(19) United States
(12) Patent Application Publication
(10) Pub. No.: US 2025/0326620 A1
(43) Pub. Date: Oct. 23, 2025

(54) MOBILE FLUID CONTAINERIZATION LINE

(71) Applicant: Heart Water, Inc., Cedar Park, TX (US)

(72) Inventor: Belal El Banna, Cedar Park, TX (US)

(21) Appl. No.: 19/176,756

(22) Filed: Apr. 11, 2025

Related U.S. Application Data
(60) Provisional application No. 63/635,382, filed on Apr. 17, 2024.

(51) Int. Cl. B67C 7/00; B01F 23/236; B01F 23/237; B01F 23/70; B01F 101/14; B67C 3/06; B67C 3/22; B67C 3/24

(52) U.S. Cl. CPC B67C 7/0006; B01F 23/2362; B01F 23/237621; B01F 23/702; B67C 3/065; B67C 3/225; B67C 3/24; B01F 2101/14; B67C 2003/228; B67C 2007/006

(57) ABSTRACT

A portable container filling system for filling bottles or cans with a fluid may include a first container housing a first plurality of equipment for depalletizing and filling containers with the fluid, and a second container housing a second plurality of equipment for packaging and palletizing filled containers. At least one piece of equipment from among the first plurality of equipment or the second plurality of equipment may be configured to be movable between a transportation configuration and an operative configuration. Movement of at least one piece of equipment may not require removal of equipment from the first container or the second container. A clean room environment may be established within at least one of the containers by creating positive air pressure with filtered air surrounding a portion of the containerization equipment. A chiller system housed within the containers may cool a fluid product before filling.

### RELATED APPLICATION

Under provisions of 35 U.S.C. § 119(e), the Applicant claims benefit of U.S. Provisional Application No. 63/635,382 filed on Apr. 17, 2024, and having inventors in common, which is incorporated herein by reference in its entirety.

It is intended that the referenced application may be applicable to the concepts and embodiments disclosed herein, even if such concepts and embodiments are disclosed in the referenced application with different limitations and configurations and described using different examples and terminology.

### FIELD OF DISCLOSURE

The present disclosure generally relates to containerization (e.g., bottling, canning, boxing, pouching, and/or the like) of fluids, and more specifically to containerization of beverages for consumption by humans or other animals.

### BACKGROUND

After production, beverages and other fluids are typically containerized for distribution to a consumer. Containerization may include, for example, placing (“filling”) the fluid into a bottle, can, box, pouch, or other container used to distribute fluids, and/or packaging the filled containers into a carrier (e.g., a box, carton, ring holder, etc.) for distribution. Large manufacturers may purchase equipment for performing these functions. However, the equipment tends to be large and expensive, making purchase by smaller manufacturers difficult or impractical.

Conventional fluid containerization systems in the beverage industry are typically fixed installations that require substantial capital investment. These systems occupy significant floor space within manufacturing facilities. Traditional filling lines consist of multiple large machines connected in sequence to perform depalletizing, filling, capping, labeling, packaging, and palletizing operations. Each piece of equipment in these systems is generally designed to be permanently installed at a specific location.

Standard containerization systems require extensive site preparation including specialized electrical connections, plumbing infrastructure, and reinforced flooring. These systems often necessitate custom installation by specialized technicians. The integration of various components in conventional systems typically involves complex mechanical and electronic interfaces that must be precisely calibrated.

Existing fluid filling equipment generally lacks mobility and flexibility. The size and weight of traditional filling machinery make transportation between different production facilities impractical. Conventional systems typically require complete disassembly for relocation, followed by reassembly and recalibration at the new site.

For smaller beverage manufacturers, the high cost of traditional containerization equipment presents a significant barrier to entry. These manufacturers often must rely on contract packaging services, which can reduce profit margins and limit production scheduling flexibility. Contract packaging also introduces additional transportation costs and potential quality control issues.

Maintenance of conventional containerization systems requires specialized technical knowledge and access to proprietary parts. Downtime for repairs or modifications can be extensive, resulting in production delays and revenue losses. The complexity of traditional systems also creates challenges for staff training and operational efficiency.

Some beverage manufacturers rely on manual or semi-automated filling processes that require significant labor resources and result in lower production throughput. These manual systems typically involve hand-filling containers using basic equipment such as gravity fillers or simple pumping mechanisms. While these approaches require less initial capital investment, they become increasingly inefficient as production volume grows.

Mobile canning services have emerged as an alternative for smaller producers. These services transport limited filling equipment to different production facilities on trucks or trailers. However, these mobile services often provide only basic filling capabilities with limited flexibility in container types and sizes. The setup and teardown processes for these services can be time-consuming, reducing effective production time.

Modular filling systems attempt to address flexibility limitations by offering component-based solutions. These systems consist of separate units for different containerization functions that can be arranged according to specific requirements. Despite their adaptability, modular systems frequently lack integration efficiency and require significant reconfiguration time when changing between product types or container formats.

Rental equipment programs provide temporary access to containerization machinery. These programs typically offer older or simplified versions of industrial equipment. Rental solutions generally lack comprehensive technical support and may have reliability issues due to frequent transportation and operation by different users with varying levels of expertise.

The limitations of existing solutions create challenges for beverage producers seeking scalable, flexible containerization options. Current alternatives either require substantial permanent infrastructure or sacrifice efficiency and quality control. Production capacity constraints imposed by inadequate equipment can prevent manufacturers from responding effectively to market demands or seasonal production requirements.

Conventional containerization solutions also present logistical challenges related to facility space utilization. Fixed installations permanently occupy manufacturing floor space that could otherwise be used for other production activities during non-filling periods. This inflexibility in space allocation creates inefficiencies in overall facility utilization.

Additionally, existing containerization systems typically require specialized environmental conditions including temperature and humidity control, further increasing infrastructure requirements. The integration of these environmental control systems with filling equipment adds complexity and cost to facility preparation.

Traditional filling equipment also faces challenges in adapting to evolving container designs and materials. Modification of conventional systems to accommodate new container formats often requires substantial reconfiguration or component replacement. This lack of adaptability limits manufacturers' ability to respond to changing market preferences or packaging innovations.

Thus, there is a need for a mobile canning and bottling line that does not require large amounts of indoor space at the site of the fluid or beverage producer. There is also a need for a mobile canning or bottling line that is not reliant in the producer site for power needs.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

A mobile fluid containerization line may include a plurality of large containers, such as International Organization for Standardization (ISO) shipping containers, tractor trailers, or the like. The containers preferably meet standards for transportation over the road. For example, standards set by the National Highway Traffic Safety Administration (NHTSA), Federal Highway Association (FHA), National Transportation Safety Board (NTSB), and/or any other state and/or national regulator of highway safety.

Containerization (e.g., canning and/or bottling) equipment may be installed within one or more (e.g., each) of the containers. One or more pieces of the equipment may be installed in a fixed location within the trailer. Additionally or alternatively, one or more pieces of equipment may be movable between an operative configuration and a storage configuration within the trailer. The storage configuration may be utilized when the equipment is being moved, while the operational configuration is used during operation of the canning or bottling line.

In embodiments, the line may span multiple trailers. For example, a conveyor belt or other means of conveyance may move cans or bottles from a first trailer to a second trailer. Preferably, the line may be organized so that two trailer parked in adjacent spaces (e.g., in a cargo bay), contain the line. The line may receive empty cans or bottles at a first end of the first trailer (adjacent to the production site), and the line may flow from the first end of the first trailer to the second end, where the cans may be moved from the first trailer to the second trailer. Thereafter, the line may convey the cans or bottles from the second end of the second trailer (most distant from the production facility) to the first end of the second trailer (at the second cargo bay). In this way, empty cans may be loaded in the first cargo bay, and filled cans may be received at the second cargo bay. The mobile containerizing line preferably produces cans or bottles at a relatively high rate of speed. For example, a mobile canning line consistent with described embodiments may produce approximately 80-100 cans per minute.

A method for mobile fluid containerization may include providing a mobile containerization line at a production facility. The mobile containerization line may comprise one or more shipping containers housing fluid containerization equipment. The method may include transitioning at least a portion of the fluid containerization equipment from a transportation configuration to an operative configuration without removing the equipment from the one or more shipping containers. A clean room environment may be established within at least one of the one or more shipping containers by creating positive air pressure with filtered air surrounding a portion of the containerization equipment. A fluid product may be cooled using a chiller system housed within the one or more shipping containers. A plurality of containers may be filled with the cooled fluid product using filling equipment disposed within the one or more shipping containers. The fluid containerization equipment may be transitioned from the operative configuration back to the transportation configuration. The mobile containerization line may be relocated from the production facility.

A mobile fluid containerization system may include a first shipping container housing depalletizing equipment and fluid filling equipment. A second shipping container may house cartoning equipment and palletizing equipment. A transfer conveyor may connect the first shipping container to the second shipping container. A clean room enclosure may surround at least a portion of the fluid filling equipment, the clean room enclosure maintaining positive air pressure with filtered air. A chiller system may be disposed within one of the shipping containers and configured to cool fluid prior to filling. A power generation system may be configured to provide electrical power to the containerization system independent of external power sources. At least a portion of the equipment in the first shipping container or the second shipping container may be movable between a transportation configuration and an operative configuration without being removed from the shipping containers.

A method for operating a mobile fluid containerization line may include relocating a portable filling line to a production facility site. The portable filling line may comprise filling equipment disposed within a plurality of shipping containers. The method may include arranging the plurality of shipping containers at the production facility site such that a first shipping container may be positioned at a first cargo dock and a second shipping container may be positioned at a second cargo dock. Equipment within at least one of the shipping containers may be reconfigured from a transportation configuration to an operative configuration without removing the equipment from the at least one shipping container. Empty containers may be received at a first end of the first shipping container. The empty containers may be rinsed using a rinser disposed within the first shipping container. The rinsed containers may be filled with fluid using a filling system disposed within the first shipping container. The filled containers may be transferred from the first shipping container to the second shipping container via a transfer conveyor. The filled containers may be packaged using equipment disposed within the second shipping container. Packaged filled containers may be output at a first end of the second shipping container.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a block diagram of a mobile containerizing line consistent with the present disclosure; and

FIG. 2 is a flow chart showing operation of the mobile containerizing line of FIG. 1.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely to provide a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such a term to mean based on the contextual use of the term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The mobile fluid containerization line described herein addresses a significant technical problem in the beverage production industry, particularly for smaller producers. Conventional containerization equipment for bottling and canning beverages tends to be prohibitively expensive, requires substantial dedicated space, and often necessitates significant infrastructure investment. These factors create substantial barriers to entry for small to medium-sized beverage producers seeking to package their products efficiently and in compliance with regulatory standards.

The portable filling line system may solve these technical challenges through a self-contained, transportable solution that may be temporarily deployed at a production facility site without requiring permanent installation or significant modification to the facility. The containerization equipment may be housed within a plurality of shipping containers or trailers that may be readily transported to and from production sites as needed.

In one example implementation, a beverage producer (e.g., a craft brewery) may utilize the portable filling line to package a seasonal beer release without investing in permanent canning equipment. The brewery may coordinate with the portable filling line operator to schedule the containerization service for a specific production run. The portable filling line, housed within two shipping containers, may arrive at the brewery and be positioned adjacent to cargo docks. Equipment within the containers may be moved from transportation configuration to operative configuration without removal from the containers. The brewery's beer may then flow directly from production tanks through the portable system's chiller, possibly through a carbonation system, and into cans at a rate of approximately 80-100 cans per minute. The sealed cans may be automatically packaged and palletized, ready for distribution, all within the self-contained environment of the shipping containers. Upon completion of the production run, the equipment may be reconfigured for transport and the entire system relocated.

In another example, a beverage producer (e.g., a small winery) may utilize the portable filling line for bottling a limited production vintage. The portable system may be configured with specialized equipment for wine bottling, including corking or cap-sealing mechanisms. The winery may benefit from the clean room environment within the system, ensuring sanitary conditions during the bottling process. The portable nature of the system may allow the winery to schedule bottling operations seasonally without maintaining dedicated bottling equipment year-round.

A third example may involve a specialty beverage producer creating functional drinks with unique ingredients that require careful handling. The portable filling line's clean room environment, temperature control capabilities, and specialized filling equipment may accommodate these requirements. The producer may utilize the system's monitoring capabilities to ensure consistent environmental conditions throughout the filling process, maintaining product integrity and quality.

A fourth example may demonstrate the system's utility in remote locations. A spring water bottling operation at a remote natural spring may utilize the portable filling line with its self-contained power generation capabilities. The system may draw water directly from the source, process it through integrated filtration and treatment systems, and bottle it on-site without requiring connection to municipal utilities.

The portable filling line may also address FDA compliance challenges that many mobile containerization services face. By maintaining a controlled environment within the containers, including a clean room with positive air pressure and filtered air supply, the system may meet or exceed regulatory requirements for beverage packaging. This may be particularly valuable for producers of beverages requiring higher levels of sanitation or those subject to stringent regulatory oversight.

For producers in developing markets or regions with unreliable infrastructure, the portable filling line may provide a complete solution with its optional generator, water processing capabilities, and self-contained operation. This may enable beverage production and packaging in areas where permanent facilities would be impractical or impossible.

The system's modular design may allow for customization based on the specific needs of different beverage types, container formats, and production volumes. Equipment may be readily reconfigured within the containers to accommodate different operational requirements without requiring complete redesign or replacement of the system.

In each of these scenarios (and many others), the portable filling line may solve the fundamental technical problem of providing professional-grade containerization capabilities without the associated permanent infrastructure requirements, capital investment, and facility modifications typically required for such operations.

The present disclosure includes many aspects and features. Moreover, while many aspects and features relate to, and are described in, the context of a mobile bottling or canning line, embodiments of the present disclosure are not limited to use only in this context.

### I. Platform Overview

This overview is provided to introduce a selection of concepts in a simplified form that are further described below. This overview is not intended to identify key features or essential features of the claimed subject matter. Nor is this overview intended to be used to limit the claimed subject matter's scope.

In embodiments, a containerizing line, such as a bottling line or canning line may be disposed within multiple (e.g., two) containers, such as shipping containers or trailers. The line may be moved (e.g., driven or hauled) to a location of a fluid or beverage production facility. The line may span the multiple trailers. For example, a conveyor belt or other means of conveyance may move cans or bottles from a first trailer to a second trailer. Preferably, the line may be organized so that the two trailers parked in adjacent spaces (e.g., in a cargo bay), contain the line. The line may receive empty cans or bottles at a first end of the first trailer (in a first cargo bay at the production facility), and the line may flow from the first end of the first trailer to the second end, where the cans or bottles may be moved from the first trailer to the second trailer. Thereafter, the line may convey the cans or bottles from the second end of the second trailer (most distant from the production facility) to the first end of the second trailer (at a second cargo bay). In this way, empty cans may be loaded in the first cargo bay, and filled cans may be received at the second cargo bay. The mobile containerizing line preferably produces cans or bottles at a relatively high rate of speed. For example, a mobile canning line consistent with described embodiments may produce approximately 80-100 cans per minute.

The mobile fluid containerization line described in this disclosure represents an innovative solution to a significant challenge faced by small to medium-sized beverage producers. This portable system may be understood as a complete, self-contained beverage packaging facility that can be temporarily deployed at production sites without requiring permanent installation or significant facility modifications.

The system may consist of multiple shipping containers or trailers that house all necessary equipment for converting empty containers (such as bottles, cans, boxes, or pouches) into filled, sealed, and packaged products ready for distribution. What makes this system particularly valuable is that the equipment remains within the containers during both transportation and operation, with certain components being reconfigurable between transport and operational positions without requiring removal.

In practical terms, the containerization line may receive empty containers at one end, process them through various stages including rinsing, filling, sealing, and packaging, and then deliver palletized finished products at the other end. The system may be capable of processing approximately 80-100 containers per minute, making it suitable for commercial-scale production runs.

Key features of the system may include a depalletizer for receiving empty containers, a rinser for cleaning containers before filling, a clean room environment that maintains positive air pressure and filtered air to ensure sanitary conditions, a filling system for dispensing product into containers, and various conveyor systems for moving products through the process. Additional components may include a chiller for cooling products, a cartoner for packaging filled containers, and a pallet lift for stacking finished products.

Optional features may further enhance the system's versatility, such as a carbonation system, drainage capture system, compressor, generator for independent power supply, and monitoring systems to ensure proper environmental conditions throughout the process.

The portable nature of this system may allow beverage producers to schedule containerization services as needed without investing in expensive permanent equipment or dedicating valuable facility space. This approach may be particularly beneficial for seasonal products, limited releases, or producers operating in remote locations or regions with unreliable infrastructure.

By maintaining a controlled environment within the containers, the system may also help producers meet FDA compliance requirements for beverage packaging, addressing another significant challenge faced by mobile containerization services.

Embodiments of the present disclosure may comprise modules or components including, but not limited to, at least one of the following:
A. A Depalletizer;
B. A Rinser;
C. A Clean Room;
D. A Filling System;
E. A Transfer Conveyor;
F. A Cartoner;
G. A Carton Transfer Conveyor; and
H. A Pallet Lift.

In some embodiments, the present disclosure may provide an additional set of modules or components for further facilitating the software and hardware platform. The additional set of modules may comprise, but not be limited to:
I. A Carbonation System;
J. A Drainage Capture System; and
K. A Monitoring system.

Details with regard to each module are provided below. Although modules are disclosed with specific functionality, it should be understood that functionality may be shared between modules, with some functions split between modules, while other functions duplicated by the modules. Furthermore, the name of each module should not be construed as limiting upon the functionality of the module. Moreover, each component disclosed within each module can be considered independently, without the context of the other components within the same module or different modules. Each component may contain functionality defined in other portions of this specification. Each component disclosed for one module may be mixed with the functionality of other modules. In the present disclosure, each component can be claimed on its own and/or interchangeably with other components of other modules.

The following depicts an example of a method of a plurality of methods that may be performed by at least one of the aforementioned components, or portions thereof. Various devices may be used at the various stages of the operations disclosed with reference to each component. For example, although methods may be described to be performed by a single component, it should be understood that, in some embodiments, different operations may be performed by different devices in operative communication with the component.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in orders that differ from the ones disclosed below. Moreover, various stages may be added or removed without altering or departing from the fundamental scope of the depicted methods and systems disclosed herein.

Consistent with embodiments of the present disclosure, a method may be performed by at least one of the components disclosed herein. The method may comprise the following stages:
Relocating a portable filling line comprised of filling equipment disposed within a plurality of containers to a production facility site;
Moving one or more pieces of equipment from a transportation configuration to an operative configuration without removing the equipment from the plurality of containers;
Operating the filling equipment to fill a plurality of bottles or cans with a fluid;
Moving one or more pieces of equipment from an operative configuration to a transportation configuration without removing the equipment from the plurality of containers; and
Relocating the portable filling line away from the production facility site.

It should be understood that, in some embodiments, different operations may be performed by different components in operative communication with one another. For example, a plurality of components may be employed in the performance of some or all of the stages in the aforementioned method. Moreover, a plurality of separate devices may be configured much like a single component. Similarly, an apparatus may be employed in the performance of some or all stages in the method.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. Platform Configuration

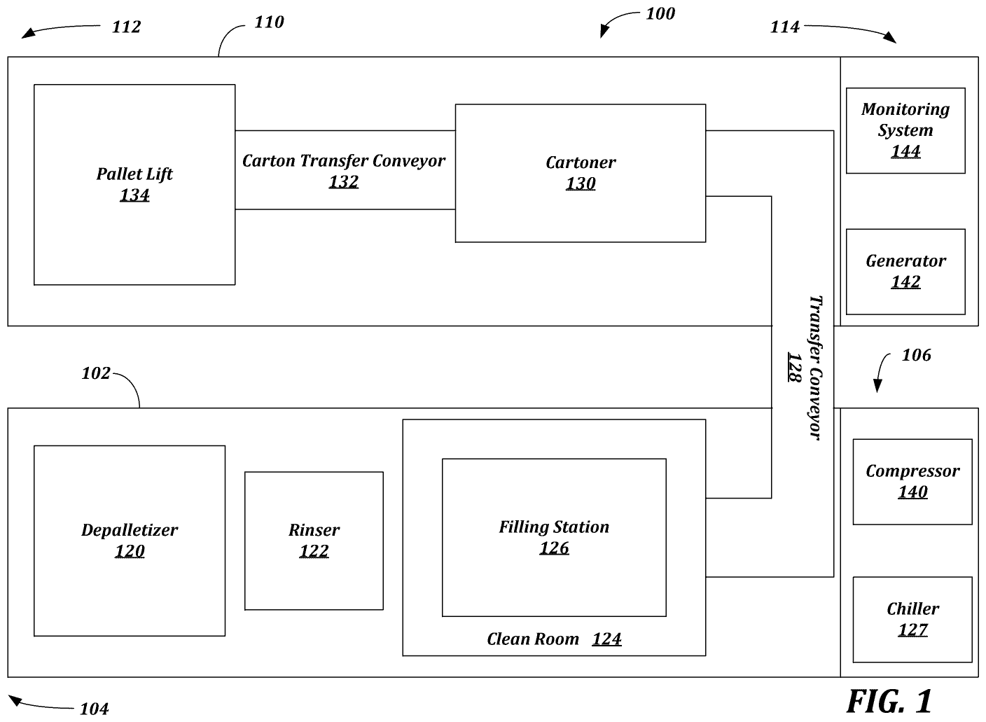

FIG. 1 illustrates one possible operating environment through which a platform consistent with embodiments of the present disclosure may be provided. By way of non-limiting example, a mobile containerizing platform 100 may include a plurality of component parts in operational connection with one another.

The components may be spread across multiple containers. For example, as shown in FIG. 1, the platform 100 may include components spread across a first container 102 and a second container 110. One or more (e.g., each) of the first container and the second container preferably include one or more access doors which permit access to various portions of the container. The access doors preferably slide, reducing the need for space around the container. In some embodiments, one or more (e.g., each) of the first container 102 and the second container 110 may include pop-out sections to provide extra room while the container is operational (e.g., being used to fill bottles or cans). In some embodiments, the first container 102 and/or the second container 110 may meet ISO container size standards. For example, the container may be approximately 40 feet long, approximately 8 feet wide, and approximately 8.5 feet tall.

The first container 102 may have a first end 104 providing an access door. The first end 104 may be configured to mate with or otherwise be disposed at a first cargo dock of a production facility. In some embodiments, the first end 104 may include a door or opening. A second end 106 of the first container 102 may be opposite the first end 104, away from the cargo dock. In embodiments, the first container 102 may include one or more pieces of equipment that fill and seal individual cans and/or bottles. As an example, the first container may include a depalletizer, a rinser (such as a twist rinser), and a filling system.

The second container 110 may have a first end 112 providing an access door. The first end 112 may be configured to mate with or otherwise be disposed at a second cargo dock of a production facility. The second cargo dock is preferably adjacent to the first cargo dock. In some embodiments, the first end 112 may include a door or opening. A second end 114 of the trailer may be opposite the first end 112, away from the cargo dock. In embodiments, the second container 110 may include one or more pieces of equipment that deposit filled cans and/or bottles into cartons or other carrying devices and palletize the finished products. As an example, the second container 110 may include a cartoner, a carton transfer conveyor, and a palletizer. The second container 110 may be operatively connected to the first container 102 by a transfer conveyor.

In embodiments, the equipment disposed within the first container 102 and/or the second container 110 may be heavy, and positioning the equipment for transport may not allow proper manufacturing flow. According, one or more pieces of the equipment may be movable between a transport configuration (e.g., to adjust the center of gravity or weight balance of the container holding the equipment) and an operative configuration (e.g., to position the equipment for efficient and safe use when filling bottle or cans).

Various movement means, such as wheels, casters, and/or tracks, may be used to allow movement of one or more pieces of equipment within the container, without unloading any of the equipment.

The mobile fluid containerization line may operate within a variety of environments, each presenting unique challenges and requirements for successful deployment and operation. The portable nature of the system may necessitate adaptability to diverse operating conditions while maintaining consistent performance and regulatory compliance.

The production facility where the portable filling line may be deployed may need to meet certain minimal requirements to accommodate the containerization system. The facility may require sufficient space for positioning the plurality of containers adjacent to cargo docks. The cargo docks may need to be of appropriate height and configuration to allow proper alignment with the container doors. A level surface may be necessary for stable positioning of the containers, with adequate load-bearing capacity to support the weight of the filled containers.

In some embodiments, the facility may need to provide access points for utilities, though these requirements may be minimal compared to traditional permanent filling lines. Water supply connections with appropriate pressure and flow rates may be needed if the optional water processing system is not utilized. Electrical supply connections may be required if the optional generator is not employed. The facility may need drainage capabilities for wastewater if the drainage capture system requires external discharge.

The portable filling line may be designed to operate within specific environmental parameters to ensure product quality and equipment reliability. The interior of the containers may be climate-controlled to maintain appropriate temperature and humidity levels regardless of external conditions. Ambient temperature ranges for optimal operation may be between approximately 50° F. and 85° F. (10° C. to 29° C.), though operation outside this range may be possible with additional environmental control measures.

Humidity levels within the containers, particularly in the clean room areas, may need to be maintained below 60% relative humidity to prevent condensation and microbial growth. The system may include dehumidification capabilities to achieve these conditions in high-humidity environments.

Air quality within the containers may be continuously monitored and controlled, with particular attention to the clean room environment. Filtration systems may remove particulates, volatile organic compounds, and other potential contaminants from the air supply. Positive pressure differential between the clean room and surrounding areas may be maintained to prevent ingress of unfiltered air.

The portable filling line may be designed to operate with minimal external utility requirements, enhancing its versatility across diverse production environments. Water supply needs may vary based on the specific containerization process, but may typically range from approximately 5 to 15 gallons per minute at pressures between 40 and 60 PSI. The optional water processing system may allow operation with lower quality water sources by providing appropriate filtration and treatment.

Compressed air may be required for various pneumatic systems within the containerization line. The integrated compressor may provide approximately 20 to 40 CFM at pressures between 80 and 100 PSI, eliminating the need for external compressed air supplies.

The portable nature of the containerization system may necessitate consideration of transportation infrastructure for deployment and relocation. Standard shipping containers or trailers may be transported via commercial trucking services, requiring appropriate road access to the production facility. Clearance heights, weight restrictions, and turning radii may need to be evaluated when planning transportation routes.

For international deployments, the containers may be designed to meet international shipping standards, allowing for transport via cargo ships and compliance with customs requirements. The equipment within the containers may be secured for transportation to prevent damage during transit, with locking mechanisms to prevent movement of movable components.

The portable filling line may incorporate features to facilitate compliance with various regulatory requirements across different operating environments. The clean room environment may be designed to meet FDA current Good Manufacturing Practice (cGMP) standards, with materials and surfaces that can be effectively cleaned and sanitized.

Documentation systems may be integrated to record operational parameters, cleaning procedures, and quality control measures as required by regulatory agencies. The monitoring system may capture and store data regarding environmental conditions, equipment performance, and product specifications for compliance verification and quality assurance purposes.

In environments where specific local regulations apply, the system may be configurable to accommodate additional requirements. For example, water usage and discharge may be monitored and controlled to comply with local environmental regulations. Noise levels during operation may be managed to meet occupational health and safety standards as well as local noise ordinances.

The portable filling line may incorporate communication systems to facilitate remote monitoring, troubleshooting, and support. Wired or wireless network connectivity may allow for data transmission to central monitoring systems or cloud-based platforms. This connectivity may enable remote diagnostics and technical support, reducing downtime and improving operational efficiency.

User interface systems may be provided for local control and monitoring of the containerization process. These interfaces may display real-time operational data, alert operators to potential issues, and provide guidance for routine procedures. Communication systems between operators in different containers may facilitate coordination during operation.

The portable filling line may include comprehensive safety systems to protect operators and equipment during transportation and operation. Emergency shutdown systems may be accessible throughout the containers to immediately halt operations if safety concerns arise. Fire detection and suppression systems may be integrated to address potential fire hazards.

Adequate lighting may be provided throughout the containers to ensure safe operation and maintenance activities. Non-slip flooring, guard rails, and other physical safety features may be incorporated to prevent accidents during operation. Personal protective equipment storage and changing areas may be included to facilitate proper safety protocols.

The portable system may be designed with maintenance requirements in mind, incorporating features to facilitate routine servicing and repairs. Access panels and removable sections may allow for maintenance of equipment without requiring complete disassembly or removal from the containers. Storage areas for spare parts and maintenance tools may be integrated into the container design.

Documentation systems may track maintenance schedules and procedures, ensuring that preventive maintenance is performed at appropriate intervals. Remote monitoring capabilities may allow for predictive maintenance based on equipment performance data, potentially reducing unplanned downtime.

The portable filling line may include features to adapt to seasonal variations and geographic-specific challenges. Additional insulation may be provided for operation in cold climates, while enhanced cooling systems may be included for hot environments. The climate control systems may be sized to maintain appropriate internal conditions regardless of external temperature extremes.

For operation in regions with unreliable water quality, enhanced filtration and treatment systems may be incorporated. In areas prone to power outages or with limited electrical infrastructure, the generator capacity may be increased to ensure continuous operation. For deployment in regions with specific seismic concerns, additional securing mechanisms may be included to stabilize equipment during seismic events.

The portable filling line may be designed to integrate with existing systems at the production facility. Interface connections for product transfer from production vessels to the filling system may be standardized to accommodate various facility configurations. Control systems may allow for synchronization with production schedules and batch tracking systems.

Data exchange capabilities may enable integration with the facility's quality control and inventory management systems. This integration may facilitate seamless tracking of products from production through containerization and distribution, enhancing traceability and quality assurance.

The portable filling line may be implemented using a variety of hardware components to enable the functionality described throughout this disclosure. The hardware components may include mechanical systems, electrical systems, control systems, monitoring systems, and/or the like working in concert to provide a complete mobile containerization solution.

The mechanical systems of the portable filling line may include various motorized components for moving containers through the containerization process. Conveyor systems may utilize food-grade belting materials mounted on stainless steel frames with variable speed motors. These motors may be three-phase AC motors with variable frequency drives (VFDs) to allow speed adjustment based on production requirements. The conveyor systems may include tracking guides and container stabilization mechanisms to prevent tipping or misalignment during transport between processing stations.

The depalletizer may include a hydraulic or electric lift system capable of raising pallets of empty containers to an appropriate height for removal and placement onto the conveyor system. The lift mechanism may incorporate safety features such as load sensors and emergency stop capabilities. A rotating platform may be incorporated into the depalletizer design to facilitate access to all containers on the pallet without requiring operator repositioning.

The rinser may utilize food-grade stainless steel construction with specialized gripping mechanisms to invert containers safely without damage. The rinser may incorporate high-pressure spray nozzles connected to a filtered water supply system. The spray system may operate at pressures between 30-60 PSI, with adjustable settings based on container type and contamination concerns. Drainage systems beneath the rinser may capture and direct rinse water to the drainage capture system.

The filling system may incorporate precision volumetric filling heads made of stainless steel and food-grade polymers. These filling heads may utilize counter-pressure filling technology for carbonated beverages or gravity filling for still beverages. The filling system may include level sensors to ensure consistent fill heights and prevent overfilling. Sealing mechanisms may vary based on container type, including can seamers with first and second operation rollers, bottle cappers with torque control, or heat sealers for flexible packaging.

The chiller may utilize a closed-loop glycol refrigeration system with stainless steel plate heat exchangers. The refrigeration system may be capable of maintaining fluid temperatures between 32° F. and 40° F. (0°° C. to 4.4° C.) depending on product requirements. Temperature sensors may monitor fluid temperature throughout the chilling process, with automated controls to maintain target temperatures.

The cartoner may include mechanical folding and gluing systems for assembling cartons around filled containers. Servo motors may control precise movements for carton forming, container insertion, and closure operations. The cartoner may incorporate vision systems to verify proper carton assembly and container placement before sealing.

The pallet lift may utilize a hydraulic system capable of raising loaded pallets to various heights for efficient stacking. The lift mechanism may include load cells to monitor weight distribution and prevent overloading. Stretch wrapping capabilities may be incorporated with a rotating platform and automated film dispensing system.

For movement between transportation and operational configurations, the equipment may be mounted on heavy-duty casters with locking mechanisms or on rail systems with securing clamps. The movement systems may include leveling capabilities to ensure proper equipment alignment regardless of container positioning. Quick-connect fittings may be utilized for fluid and electrical connections to facilitate reconfiguration between operational and transportation modes.

In embodiments, the equipment mounts may incorporate vibration damping mechanisms, such as springs, shock absorbers, pneumatic dampers, hydraulic dampers, and/or the like to reduce or eliminate vibration during transportation. The vibration damping mechanisms may help to maintain equipment during transportation. The vibration-reducing hardware for mounting the equipment may include a variety of specialized components designed to minimize vibration transmission during transportation and operation of the portable filling line. The equipment mounts may incorporate multi-axis vibration isolation systems utilizing a combination of mechanical springs, elastomeric isolators, and fluid dampers. These isolation systems may be strategically positioned at key mounting points between the equipment and the container structure to absorb vibrations across different frequency ranges.

For heavy equipment such as the filling system and depalletizer, the vibration-reducing hardware may include pneumatic isolation mounts that may be adjustable based on equipment weight and expected vibration profiles. These pneumatic mounts may utilize compressed air chambers that may automatically level the equipment while providing vibration dampening. The air pressure within these mounts may be adjustable to accommodate different road conditions during transportation or operational requirements when stationary.

Hydraulic shock absorbers may be incorporated into the mounting systems for equipment that may experience sudden load changes or impacts. These shock absorbers may convert kinetic energy from vibrations into heat energy through fluid displacement, effectively reducing the transmission of vibration to sensitive components. The hydraulic systems may include accumulators to handle pressure spikes and maintain consistent damping performance across varying conditions.

For precision equipment within the clean room environment, the vibration-reducing hardware may include tuned mass dampers that may be calibrated to counteract specific resonant frequencies common during road transportation. These dampers may consist of secondary mass-spring systems that may oscillate out of phase with the primary vibration, effectively neutralizing the motion. The tuning of these dampers may be optimized based on transportation route analysis and equipment sensitivity requirements.

The mounting systems for conveyor sections may utilize flexible couplings and segmented designs that may allow for controlled movement without transmitting vibrations between connected components. These flexible connections may incorporate elastomeric elements with specific shore hardness ratings selected to absorb vibrations while maintaining proper alignment of the conveyor system during operation.

For electronic control systems and sensitive instrumentation, the vibration-reducing hardware may include isolation platforms with wire rope isolators. These isolators may provide multi-directional damping through the controlled deformation of stainless-steel wire rope elements. The wire rope configuration may be designed to provide different damping characteristics in vertical and horizontal directions, addressing the complex vibration profiles experienced during transportation.

The vibration-reducing hardware may also include inertia bases for equipment with rotating components such as pumps and compressors. These bases may consist of steel frames filled with concrete or other high-density materials to increase the mass of the mounting system. The increased mass may reduce the amplitude of vibrations by decreasing the acceleration response to vibratory forces. The inertia bases may be mounted on isolation pads or springs to further reduce vibration transmission to the container structure.

Viscoelastic damping layers may be incorporated between equipment frames and mounting points to dissipate vibration energy through molecular friction. These damping layers may convert vibration energy into heat through the shearing action of the viscoelastic material. The composition and thickness of these layers may be selected based on the expected temperature range and vibration frequency spectrum during transportation and operation.

The vibration-reducing hardware may include active vibration control systems for particularly sensitive equipment. These systems may utilize sensors to detect vibrations, processors to analyze the vibration patterns, and actuators to generate counteracting forces. The active systems may be particularly effective for low-frequency vibrations that may be difficult to address with passive isolation methods. The control algorithms may adapt to changing conditions during transportation and operation to maintain optimal vibration suppression.

For equipment that may need to be moved between transportation and operational configurations, the vibration-reducing hardware may include locking mechanisms that may secure the equipment during transportation while allowing controlled movement during reconfiguration. These mechanisms may incorporate gas springs or counterbalance systems to facilitate the movement of heavy equipment while maintaining vibration isolation properties. The locking systems may be designed for tool-free operation to minimize setup and breakdown time.

The electrical systems of the portable filling line may include main power distribution panels in each container with appropriate circuit protection devices. These panels may accept either shore power from the production facility or power from the optional generator. The electrical system may operate on 480V three-phase power with step-down transformers for 240V and 120V components as needed.

A programmable logic controller (PLC) system may serve as the central control mechanism for the containerization line. The PLC may be housed in a sealed, climate-controlled enclosure to protect against environmental factors. Human-machine interface (HMI) touchscreen panels may be strategically located throughout the containers to allow operator control and monitoring of various subsystems.

Variable frequency drives may control motor speeds throughout the system, allowing for adjustment based on production requirements and container types. These drives may include regenerative braking capabilities to improve energy efficiency during deceleration phases.

Safety systems may include emergency stop buttons positioned at key locations throughout the containers, with redundant circuits to ensure reliable operation. Light curtains and presence sensing devices may be incorporated around moving equipment to prevent operator injury. Interlocks may prevent operation of equipment when access doors or panels are open.

The clean room environment may be maintained through HEPA filtration systems with dedicated blower motors. Pressure differential sensors may monitor the positive pressure within the clean room relative to surrounding areas. UV germicidal irradiation may be incorporated into the air handling system to reduce microbial contamination.

The optional generator may be a diesel or natural gas-powered unit with sufficient capacity to operate all systems simultaneously. The generator may include automatic voltage regulation and frequency control to provide stable power regardless of load variations. An automatic transfer switch may facilitate seamless transition between shore power and generator power if utility power is interrupted.

The monitoring system may include a network of sensors connected to a central data acquisition system. Temperature sensors may monitor ambient conditions as well as product temperatures at various stages. Humidity sensors may track environmental conditions within the clean room and other critical areas. Air quality sensors may monitor particulate levels, volatile organic compounds, and other potential contaminants.

Pressure transducers may monitor compressed air system performance, hydraulic system pressures, and fluid transfer pressures throughout the containerization process. Flow meters may track water usage, product transfer rates, and other fluid movements within the system. Vibration sensors may monitor equipment performance to detect potential mechanical issues before failures occur.

A central computer system may collect and process data from all sensors, providing real-time monitoring capabilities and historical data logging for quality assurance purposes. This system may include remote access capabilities to allow technical support from off-site personnel. Alert systems may notify operators of conditions outside acceptable parameters, with escalating notification levels based on severity.

Communication systems may include internal networks utilizing industrial Ethernet protocols for equipment control and monitoring. Wireless access points may provide connectivity throughout the containers for mobile devices used by operators and maintenance personnel. External communication capabilities may include cellular or satellite connections for remote monitoring and support when local internet infrastructure may not be available.

The water processing capabilities may include multi-stage filtration systems starting with sediment filters to remove particulates, followed by carbon filtration to remove chemicals and improve taste. UV sterilization systems may provide disinfection without chemical additives. Reverse osmosis systems may be incorporated for applications requiring extremely pure water.

The carbonation system may utilize a carbonation stone or sintered metal diffuser to introduce carbon dioxide into chilled product. Pressure regulation systems may control the level of carbonation based on product specifications. In-line carbonation measurement devices may verify carbonation levels before filling.

The drainage capture system may include stainless steel troughs and drains throughout the containers, directing liquid to collection tanks. These tanks may include level sensors to prevent overflow and pumps to transfer collected liquid to appropriate disposal systems or for recycling where applicable.

The compressor system may provide clean, dry air for pneumatic components throughout the containerization line. The compressor may be a rotary screw type with appropriate filtration and drying capabilities to meet food-grade air requirements. Pressure regulation systems may distribute compressed air at appropriate pressures for various subsystems.

All hardware components may be designed for compliance with FDA requirements for food contact surfaces, including appropriate materials selection and surface finishes. Stainless steel construction may be utilized for components in direct contact with product or containers, with food-grade polymers used where appropriate. All systems may be designed for thorough cleaning and sanitization between production runs, with CIP (Clean-In-Place) capabilities incorporated where feasible.

The portable filling line may include specialized tools and equipment for maintenance and troubleshooting, stored in dedicated areas within the containers. Spare parts for critical components may be maintained on-board to minimize downtime in the event of component failures. Documentation systems may include digital and physical copies of equipment manuals, maintenance procedures, and troubleshooting guides.

The hardware systems may be designed with modularity in mind, allowing for component upgrades or replacements as technology advances or requirements change. Standardized connections and interfaces may facilitate integration of new equipment or capabilities without requiring complete system redesign.

Accordingly, embodiments of the present disclosure provide components including, but not limited to:

### A. A Depalletizer

As shown in FIG. 1, the platform 100 may include a depalletizer 120. As shown in FIG. 1, the depalletizer 120 is preferably disposed in the first container, though other arrangements may be possible. As is known in the art, bottles and cans are often ordered by the pallet.

The depalletizer 120 may be configured to receive and process pallets of empty cans or bottles for introduction into the containerization line. The depalletizer 120 may include a pallet receiving platform that may be positioned at the first end 104 of the first container 102, allowing for efficient loading of palletized containers from the production facility's cargo dock. The pallet receiving platform may be adjustable in height to accommodate various pallet configurations and/or to align with the cargo dock height.

The depalletizer 120 may receive and retain or store a pallet of empty cans or bottles to be filled. The bottles or cans may be placed on the depalletizer 120 for introduction into the bottling or canning line. The bottles or cans may be removed from the pallet on the depalletizer 120 by a worker (e.g., a human or robotic worker) and placed on the bottling or canning line to be filled. In some embodiments, the depalletizer 120 may rotate about a central axis and/or move up and/or down to allow for easier access to the bottles and/or cans loaded on the pallet.

In some embodiments, a roof of a container (e.g., the first container 102) in which the depalletizer 120 is disposed may be modified by raising the roof at least in the vicinity of the depalletizer to facilitate depalletization.

In some embodiments, the depalletizer 120 may include a motorized lift mechanism that may raise the pallet incrementally as layers of containers are removed. This lift mechanism may utilize hydraulic cylinders, electric actuators, or other suitable lifting devices capable of supporting the weight of fully loaded pallets. The lift mechanism may be controlled through an operator interface panel or may function automatically through sensors that may detect when a layer has been depleted.

The depalletizer 120 may incorporate a rotational capability, allowing the pallet to rotate about a vertical axis. This rotational feature may provide operators with access to all sides of the pallet without requiring repositioning of the pallet or operator movement around the pallet. The rotation mechanism may include a bearing assembly mounted beneath the pallet platform and may be powered by an electric motor with variable speed control.

For stability during transportation, the depalletizer 120 may be equipped with locking mechanisms that may secure the lift platform and rotational components in a fixed position. These locks may be manually engaged or may automatically activate when the system is configured for transport. When in the transportation configuration, the depalletizer 120 may be positioned to optimize weight distribution within the first container 102.

The depalletizer 120 may include guide rails or alignment features that may assist in proper positioning of pallets when loaded. These guides may be adjustable to accommodate different pallet sizes and configurations. In some embodiments, the depalletizer 120 may include sensors to verify proper pallet placement before operation begins.

For enhanced functionality, the depalletizer 120 may incorporate a layer separator mechanism that may assist in removing slip sheets or tier sheets between layers of containers on the pallet. This mechanism may utilize vacuum cups, mechanical grippers, or other means to grasp and remove the separator sheets as each layer is accessed.

In some embodiments, the depalletizer 120 may include a container sweep system that may gently move containers from the pallet onto a receiving conveyor. This sweep system may utilize padded pusher bars that may move in a synchronized pattern to transfer containers without tipping or damaging them. The sweep system may be adjustable to accommodate different container sizes and configurations.

The depalletizer 120 may include safety features such as presence-sensing devices that may detect operator proximity and automatically stop movement if an operator enters a designated safety zone. Emergency stop buttons may be positioned at strategic locations around the depalletizer 120 for immediate shutdown if needed.

For operation in limited height environments, the depalletizer 120 may be designed with a low-profile configuration. In some embodiments, the roof of the first container 102 may include a raised section or pop-out extension specifically in the area above the depalletizer 120 to provide additional vertical clearance for pallet loading and unloading operations.

The depalletizer 120 may include a control system that may be integrated with the overall containerization line control architecture. This integration may allow for synchronized operation with downstream equipment and may enable automatic adjustment of depalletizing speed based on line conditions.

In some embodiments, the depalletizer 120 may include a container counting system that may track the number of containers processed. This information may be used for inventory management and production reporting. The counting system may utilize optical sensors, weight measurement, or other suitable detection methods.

The depalletizer 120 may be mounted on heavy-duty casters or rails that may allow for movement between the transportation configuration and the operative configuration. These movement mechanisms may include locking features to secure the depalletizer 120 in position during operation. The movement system may be designed to allow repositioning without requiring specialized equipment or excessive force.

For enhanced efficiency in multi-product runs, the depalletizer 120 may include quick-change features that may facilitate rapid changeover between different container sizes or types. These features may include adjustable guides, removable format parts, and tool-less adjustment points that may be reconfigured without requiring extensive downtime.

The depalletizer 120 may be designed with energy efficiency in mind, utilizing variable speed drives for motors and power-saving modes when not actively processing containers. The electrical components may be rated for the environmental conditions within the container and may include protection against dust and moisture ingress.

### B. A Rinser

As shown in FIG. 1, the platform 100 may include a rinser 122. As shown in FIG. 1, the rinser 122 is preferably disposed in the first container 102, though other arrangements may be possible. The rinser 122 may receive cans and/or bottles (e.g., from the depalletizer 120), and may rinse the cans and/or bottle using a fluid. Typically, the rinsing fluid is filtered or sterilized water, though other fluids, such as a liquid sanitizer and/or ionized air may be used for rinsing in place of or in addition to the water.

As one non-limiting example, the rinser 122 may be a twist rinser, as is known in the art. The twist rinser may receive a can or bottle, inverts the can or bottle (such that the opening faces downward). The twist rinser may rinse the inverted can or bottle with the rinsing fluid, allowing the fluid to flush any particles or debris from the can and fall downward out of the can. The twist rinser then re-inverts the can or bottle to continue om the canning or bottling line. The rinser 122 may be configured to clean and sanitize containers before they enter the filling system. The rinser 122 may be positioned within the first container 102 between the depalletizer 120 and the filling system 126, ensuring that all containers undergo proper cleaning before product contact. The rinser 122 may be mounted on a movable platform that may allow for repositioning between transportation and operational configurations without requiring removal from the container.

In some embodiments, the rinser 122 may utilize a twist rinse mechanism that may invert containers to facilitate thorough cleaning. The twist rinse mechanism may include a series of gripping devices that may securely hold containers during the inversion process. These gripping devices may be designed to accommodate various container sizes and shapes through adjustable settings or interchangeable components.

The rinser 122 may incorporate high-pressure spray nozzles that may direct filtered water, sanitizing solution, or ionized air into the inverted containers. The spray pattern may be engineered to provide substantially complete coverage of the interior surfaces of the containers. The pressure of the spray may be adjustable based on container type and/or material to ensure effective cleaning without causing damage.

For water conservation, the rinser 122 may include a recirculation system that may filter and reuse rinse water for a predetermined number of cycles before discharge. This recirculation system may include filtration components to remove particulates and maintain water quality throughout the production run. The system may monitor water quality parameters and may automatically refresh the water supply when predetermined thresholds are reached.

In the operational configuration, the rinser 122 may be positioned to allow for workflow from the depalletizer 120 through the rinser and to the filling system 126. The height of the rinser 122 may be adjustable to ensure proper alignment with adjacent equipment and to accommodate different container heights. This adjustment may be accomplished through mechanical or hydraulic systems that may be operated without requiring extensive disassembly.

For transportation, the rinser 122 may be secured in a configuration that may optimize weight distribution within the first container 102. Locking mechanisms may prevent movement during transit, protecting both the rinser 122 and surrounding equipment from damage. These locks may be designed for quick release when transitioning to the operational configuration.

The rinser 122 may include a drainage system that may capture and direct used rinse media to the drainage capture system 138. The drainage pathways may be designed to prevent splashing or overspray that could contaminate surrounding areas. The drainage system may include screens or filters to capture any debris removed from containers during the rinsing process.

Control systems for the rinser 122 may allow for adjustment of rinse duration, spray pressure, and container handling speed. These parameters may be modified based on container type, production requirements, and the nature of potential contaminants. The control interface may be integrated with the overall containerization line control system for coordinated operation.

The rinser 122 may incorporate sensors to verify proper container orientation and rinse completion before releasing containers to the next stage of the process. These sensors may detect container presence, proper inversion, and successful return to upright position. If any issues are detected, the system may automatically reject affected containers or alert operators to the problem.

For enhanced sanitization capabilities, the rinser 122 may include UV light exposure and/or ozone treatment options that may provide additional microbial reduction without chemical residues. These treatment methods may be particularly valuable for sensitive products or when working with containers that may be difficult to rinse thoroughly using conventional methods.

The rinser 122 may be designed with energy efficiency in mind, utilizing variable speed drives and optimized spray patterns to minimize water and power consumption. The system may include automatic shutdown features for spray nozzles when no containers are present, further reducing resource usage during production pauses.

In some embodiments, the rinser 122 may include a pre-rinse inspection system that may identify and reject containers with visible contamination or damage before they enter the rinsing process. This inspection may utilize cameras or other sensing technologies to detect foreign objects, cracks, or deformations that could compromise container integrity.

The rinser 122 may be equipped with quick-connect fittings for water supply and drainage connections, facilitating rapid setup and teardown when deploying or relocating the containerization line. These connections may include backflow prevention devices to protect the water supply from potential contamination.

For operation in environments with limited water availability, the rinser 122 may be configurable to operate with minimal water consumption through highly efficient spray nozzles and extended water recirculation capabilities. In extreme cases, the system may be adapted to operate with ionized air only, providing a dry cleaning option when water usage must be minimized.

The rinser 122 may include a self-cleaning cycle that may flush spray nozzles and internal pathways between production runs or during extended pauses. This self-cleaning capability may help prevent buildup of minerals or biological growth that could compromise rinse effectiveness or contaminate containers.

### C. A Clean Room

As shown in FIG. 1, a clean room 124 may surround at least a portion of the platform 100. As shown in FIG. 1, the clean room 124 is preferably disposed in the first container 102, though other arrangements may be possible. For example, the clean room may surround the portion of the platform 100 following the rinsing of the cans or bottles and prior to the sealing of the cans or bottles. The clean room 124 may have higher (positive) air pressure, when compared to areas that surround the clean room, helping to prevent air flow from outside of the clean room. In some embodiments, the clean room may have a filtered air supply and/or a temperature-controlled air supply. In embodiment, the clean room may comply with FDA regulations for food and beverage handling. As a specific example, the clean room may adhere to current Good Manufacturing Practice (cGMP) standards set forth by the FDA.

Proprietary water, air and electrical fittings used in at least the clean room 124 may help to ensure air-tight seals between connections and inlets/outlets to protect the integrity of the clean room and optionally, other portions of the container. For example, such fittings may help to ensure that the container (e.g., the first container 102) meets FDA standards for a food and beverage manufacturing environment.

### D. A Filling System

As shown in FIG. 1, the platform 100 may include a filling system 126. In embodiments, the filling station 126 may be disposed partially or entirely within the clean room 124. As shown in FIG. 1, the filling system 126 is preferably disposed in the first container 102, though other arrangements may be possible. The filling station may be used to fill the bottles or cans with the fluid produced at the production facility. In various embodiments, the fluid may be water, juice, or other beverages; the fluid may be carbonated or uncarbonated; the fluid may be packaged for consumption by humans or animals. The filling station 126 may be mounted on a movable platform that may allow for repositioning between transportation and operational configurations without requiring removal from the container.

In the operational configuration, the filling station 126 may be positioned to optimize workflow from the rinser 122 through the filling process. The height of the filling station 126 may be adjustable to ensure proper alignment with adjacent equipment and to accommodate different container heights. This adjustment may be accomplished through mechanical or hydraulic systems that may be operated without requiring extensive disassembly.

Rinsed cans (e.g., received from the rinser 122) may optionally be purged of oxygen. Purging may be accomplished by filling the cans with an inert gas, such as nitrogen gas or carbon dioxide. The purging process helps to limit exposure of the fluid to oxygen, thus reducing fluid oxidation. When purging is desired, the filling system 126 may include a supply of the inert gas used for purging in fluid communication with a dispensing nozzle for dispensing the gas into the can or bottle.

The filling system 126 may fill the bottle or can with the fluid. In some embodiments, the filling system may include a fluid tank containing the fluid to be used for filling. Additionally or alternatively, the filling system 126 may include a tube, pipe, and/or hose in fluid communication with a fluid source (e.g., a fluid tank at the production facility) for conveying the fluid to the filling system.

The filling station 126 may optionally incorporate a multi-head filling system that may allow for simultaneous filling of multiple containers. The number of filling heads may vary based on container size and/or production volume requirements. Each filling head may be individually controlled to ensure consistent fill volumes across all containers. The filling heads may be constructed of food-grade stainless steel and other FDA-approved materials suitable for beverage contact.

For carbonated beverages, the filling station 126 may utilize counter-pressure filling technology that may equalize pressure within the container before filling to minimize foaming and product loss. For still beverages, the filling station 126 may employ gravity or low-pressure filling methods that may be gentler on the product. The filling system may be configurable to accommodate different filling methodologies based on product characteristics.

The filling station 126 may include precision volumetric or flow metering systems that may ensure accurate fill levels for each container. These systems may be adjustable to accommodate different container sizes and fill volumes. Sensors may monitor fill levels and may automatically adjust filling parameters to maintain consistency throughout the production run.

Following the filling process, the filling station 126 may incorporate sealing mechanisms appropriate for the container type. For cans, this may include a seaming system that may apply and seal lids to the filled containers. For bottles, this may include capping, corking, or other closure application systems. The sealing mechanisms may be adjustable to accommodate different container and closure types.

In some embodiments, the filling system 126 may optionally include a chiller for use in filling the bottles or cans with the fluid. The filling system 126 may optionally cool the fluid substantially on-demand for filling. For example, the chiller may cool the fluid to a temperature of approximately 35° F., though warmer or cooler temperatures are contemplated. Following filling, the filling station may seal the bottle or can. For example, the filling station 126 may attach (“seam”) a can lid to a filled can or seal a bottle using a cap or cork.

The filling station 126 may be capable of filling an average of 80-100 containers per minute, though those of skill in the art will recognize that filling rates higher or lower than the average are possible without departing from the scope of the invention.

The filling station 126 may include a container rejection system that may identify and remove containers with improper fill levels or sealing issues. This system may utilize vision systems, weight verification, or other sensing technologies to detect defects. Rejected containers may be diverted to a separate collection area for inspection or disposal.

For transportation, the filling station 126 may be secured in a configuration that may optimize weight distribution within the first container 102. Locking mechanisms may prevent movement during transit, protecting both the filling station 126 and surrounding equipment from damage. These locks may be designed for quick release when transitioning to the operational configuration.

The filling station 126 may include a clean-in-place (CIP) system that may facilitate thorough cleaning and sanitization of product contact surfaces between production runs. The CIP system may include spray balls, circulation pumps, and chemical dosing equipment that may deliver cleaning and sanitizing solutions to all internal surfaces. The system may be programmed to execute predetermined cleaning cycles with appropriate temperature, chemical concentration, and duration parameters.

Control systems for the filling station 126 may allow for adjustment of fill speed, fill volume, and sealing parameters. These parameters may be modified based on container type, product characteristics, and production requirements. The control interface may be integrated with the overall containerization line control system for coordinated operation.

The filling station 126 may incorporate features to minimize product waste during startup, shutdown, and changeover operations. These features may include product recovery systems that may capture and recirculate product during line priming and purging. The system may also include automatic shutdown sequences that may minimize product loss in the event of unexpected stoppages.

For enhanced product quality, the filling station 126 may include dissolved oxygen monitoring capabilities that may help prevent excessive oxygen pickup during the filling process. This monitoring may be particularly valuable for oxygen-sensitive products such as beer or wine. The system may automatically adjust filling parameters to minimize oxygen introduction based on real-time measurements.

The filling station 126 may be equipped with quick-connect fittings for product supply, compressed air, and other utility connections, facilitating rapid setup and teardown when deploying or relocating the containerization line. These connections may include sanitary fittings that may comply with FDA requirements for beverage processing equipment.

For operation with a wide range of products, the filling station 126 may include product changeover features that may minimize cross-contamination between different production runs. These features may include dedicated product pathways or easily removable product contact parts that may be exchanged between runs. The system may also include automated product changeover sequences that may guide operators through the necessary steps for switching between different products.

### E. A Transfer Conveyor

As shown in FIG. 1, the platform 100 may include a transfer conveyor 128. The transfer conveyor 128 may be used to transfer cans or bottles (e.g., after filling at the filling station 126) from the first container 102 to the second container 110.

In embodiments, the transfer conveyor 128 may comprise a belt conveyor system, a gravity roller conveyor system, a live roller conveyor system, a motorized roller conveyor system, and/or combinations thereof. The transfer conveyor 128 may exit the first container 102 through a first aperture in a side wall of the container, and may enter the second container 110 through a corresponding second aperture in a side wall of the second container.

The transfer conveyor 128 may optionally be covered on one or more sides. For example, the transfer conveyor 128 may have a top covering and/or side coverings. While the bottles and/or cans are sealed, it may be necessary or desirable for the conveyor 128 to be at least partially covered to protect the bottles or cans from the elements and/or to reduce the possibility of debris collecting on an exterior surface of the bottle or can. The transfer conveyor 128 may be designed to efficiently move filled containers from the first container 102 to the second container 110, serving as a link in the mobile fluid containerization process. The transfer conveyor 128 may utilize a food-grade belt system constructed of materials compliant with FDA regulations for beverage contact surfaces. This belt system may be supported by a frame with adjustable height capabilities to ensure proper alignment with equipment in both containers.

The transfer conveyor 128 may exit the first container 102 through a first aperture in the side wall of the container. This aperture may be designed with sealed edges and flexible gaskets to prevent environmental contamination while allowing container passage. The conveyor 128 may then enter the second container 110 through a corresponding second aperture in the side wall, similarly designed with appropriate sealing mechanisms. The alignment between these apertures may be facilitated by guide pins or other alignment features that may help to ensure precise positioning when the containers are placed adjacent to each other.

For protection against environmental elements, the transfer conveyor 128 may include a protective covering system. This covering may consist of a top canopy and side panels that may shield the filled containers during their transit between the containers. The covering materials may be constructed of lightweight, weather-resistant materials that may provide protection while minimizing additional weight. The covering system may be designed with removable or hinged sections to allow for easy access during maintenance or clearing of potential container jams.

The transfer conveyor 128 may optionally incorporate container guides along its length to prevent tipping or misalignment during transport. These guides may be adjustable to accommodate different container sizes and shapes. The guide system may utilize low-friction materials to prevent container damage while ensuring proper orientation throughout the transfer process.

The drive system for the transfer conveyor 128 may include a variable speed motor with a direct or belt drive connection to the conveyor rollers or belt. The motor may be controlled through the central control system, allowing for synchronization with upstream and downstream equipment. Speed sensors may monitor conveyor operation and may automatically adjust motor output to maintain consistent container flow rates regardless of load variations.

For transportation between facilities, the transfer conveyor 128 may be designed with a folding or telescoping mechanism that may allow it to be compactly stored within one of the containers. This mechanism may include hinged sections or sliding components that may be secured during transport and deployed during setup. The deployment process may be designed to require minimal effort and may be accomplished without specialized tools.

The transfer conveyor 128 may include sensing systems to monitor container flow and detect potential issues. These sensors may include photoelectric eyes or proximity sensors that may detect container presence and spacing. The sensing system may be integrated with the control architecture to provide real-time feedback on conveyor operation and may trigger alerts if abnormal conditions are detected.

The transfer conveyor 128 may be designed with consideration for cleaning and sanitization requirements. The belt or roller surface may be easily accessible for cleaning, and the frame may be designed without horizontal surfaces or crevices that could collect debris or liquid. Drainage features may be incorporated to prevent liquid accumulation during cleaning procedures.

For enhanced functionality, the transfer conveyor 128 may include accumulation capabilities that may allow containers to queue temporarily if downstream equipment experiences a momentary stoppage. This accumulation feature may help maintain continuous operation of upstream equipment during minor disruptions. The accumulation system may include pressure-sensitive controls that may prevent excessive back pressure on containers during accumulation periods.

The transfer conveyor 128 may be equipped with emergency stop capabilities that may be integrated with the overall safety system of the containerization line. Emergency stop buttons may be positioned at strategic locations along the conveyor length, allowing operators to quickly halt operation if safety concerns arise. The emergency stop system may include redundant circuits to ensure reliable operation.

The transfer conveyor 128 may be mounted on a stable base with leveling capabilities to ensure proper operation regardless of slight variations in container positioning or ground surface. The leveling system may include adjustable feet or other mechanisms that may be fine-tuned during setup to ensure optimal conveyor performance.

For enhanced reliability, the transfer conveyor 128 may incorporate redundant drive systems or quick-change components that may minimize downtime in the event of mechanical issues. Critical components may be designed for rapid replacement without requiring extensive disassembly or specialized tools. Spare parts for these components may be stored within the containers for immediate availability when needed.

### F. A Cartoner

As shown in FIG. 1, the platform 100 may include a cartoner 130. As shown in FIG. 1, the cartoner 130 is preferably disposed in the second container 110, though other arrangements may be possible.

The cartoner 130 may be designed to efficiently package filled containers into cartons, boxes, or other secondary packaging formats. The cartoner 130 may be positioned within the second container 110 to receive filled containers from the transfer conveyor 128. The cartoner 130 may be mounted on a movable platform that may allow for repositioning between transportation and operational configurations without requiring removal from the container.

In the operational configuration, the cartoner 130 may be positioned to optimize workflow from the transfer conveyor 128 through the packaging process. The height of the cartoner 130 may be adjustable to ensure proper alignment with adjacent equipment and to accommodate different container and carton configurations. This adjustment may be accomplished through mechanical or hydraulic systems that may be operated without requiring extensive disassembly.

The cartoner 130 may receive filled bottles or cans (e.g., from the filling station 126 and/or via the transfer conveyor 128) for cartoning. Cartoning may include, for example, placement of the filled bottles or cans within a carrier such as (but not limited to) a carton, box, plastic wrap, can carrier, and/or the like. Operation of the cartoner 130 may be dependent upon, among other things, the type of carrier used to contain the bottles or cans. As examples, the cartoner 130 may be used to position the bottles or cans, place the can carrier, fold and/or seal the carton, position the can carrier, seal the plastic wrapping, and/or any other operation that may assist an operator (e.g., a human or robot) with placing the bottles or cans in the carrier.

The cartoner 130 may incorporate a carton magazine that may store flat, unformed carton blanks for use in the packaging process. The magazine may be designed for easy loading and may include capacity indicators to alert operators when replenishment is needed. The magazine may be adjustable to accommodate different carton sizes and styles, allowing for versatility across various packaging formats.

For carton forming, the cartoner 130 may utilize a series of mechanical folders and glue applicators that may transform flat carton blanks into three-dimensional packages. The folding mechanisms may include precision-controlled servo motors that may ensure accurate and consistent carton formation. Glue applicators may dispense food-grade adhesive in precise patterns to secure carton flaps and panels.

The cartoner 130 may include a container grouping system that may arrange filled containers into the appropriate configuration for insertion into cartons. This grouping system may utilize dividers, lane guides, or other mechanisms to organize containers into rows and layers. The grouping system may be adjustable to accommodate different container sizes and carton configurations.

For container insertion, the cartoner 130 may employ a push mechanism that may gently move grouped containers into formed cartons. This mechanism may utilize padded pusher plates or fingers that may apply even pressure to prevent container damage during insertion. The insertion system may include sensors to verify proper container placement before carton closure.

The cartoner 130 may incorporate a carton closing system that may fold and seal the remaining carton flaps after container insertion. This system may include mechanical folders and compression belts that may ensure secure closure. For cartons requiring adhesive sealing, the system may include additional glue applicators specifically for closure operations.

For transportation, the cartoner 130 may be secured in a configuration that may optimize weight distribution within the second container 110. Locking mechanisms may prevent movement during transit, protecting both the cartoner 130 and surrounding equipment from damage. These locks may be designed for quick release when transitioning to the operational configuration.

The cartoner 130 may include a rejection system that may identify and remove improperly formed cartons or packages with missing or damaged containers. This system may utilize vision systems, weight verification, or other sensing technologies to detect defects. Rejected packages may be diverted to a separate collection area for inspection or rework.

Control systems for the cartoner 130 may allow for adjustment of carton forming, container grouping, and sealing parameters. These parameters may be modified based on carton type, container configuration, and production requirements. The control interface may be integrated with the overall containerization line control system for coordinated operation.

For enhanced flexibility, the cartoner 130 may be capable of handling multiple carton styles and configurations. Quick-change format parts may allow for rapid transitions between different packaging formats. These format parts may be designed for tool-less installation to minimize changeover time and complexity.

For operation with a wide range of products and packaging formats, the cartoner 130 may include digital recipe storage capabilities that may allow operators to quickly recall settings for previously run products. These recipes may include all necessary parameters for carton forming, container grouping, and sealing operations. The recipe system may be integrated with the control architecture to facilitate rapid changeovers between different product runs.

For enhanced product tracking, the cartoner 130 may incorporate coding systems that may apply date codes, lot numbers, or other traceability information to cartons during the packaging process. These coding systems may utilize inkjet printers, laser markers, or other appropriate technology based on carton material and information requirements. The coding system may be integrated with the production facility's inventory management system for seamless tracking throughout the distribution chain.

### G. A Carton Transfer Conveyor

As shown in FIG. 1, the platform 100 may include a carton transfer conveyor 132. As shown in FIG. 1, the carton transfer conveyor 132 is preferably disposed in the second container 110, though other arrangements may be possible.

In embodiments, the carton transfer conveyor 132 may comprise a belt conveyor system, a gravity roller conveyor system, a live roller conveyor system, a motorized roller conveyor system, and/or combinations thereof. The carton transfer conveyor 132 may receive packaged bottles or cans, secured in a carrier (e.g., from the cartoner 130), and may convey the packaged bottles or cans to a pallet lift, inspection station, or other area.

The carton transfer conveyor 132 may be designed to efficiently transport packaged containers from the cartoner 130 to subsequent processing stations such as the pallet lift 134. The carton transfer conveyor 132 may utilize a food-grade belt system constructed of materials compliant with FDA regulations for beverage packaging operations. This belt system may be supported by a frame with adjustable height capabilities to ensure proper alignment with adjacent equipment within the second container 110.

For product flow, the carton transfer conveyor 132 may incorporate variable speed control capabilities that may allow for synchronization with upstream and downstream equipment. The speed control system may utilize a variable frequency drive connected to an energy-efficient motor that may provide consistent power while minimizing energy consumption. Speed sensors may monitor conveyor operation and may automatically adjust motor output to maintain consistent package flow rates regardless of load variations.

The carton transfer conveyor 132 may include side guides that may be adjustable to accommodate different carton sizes and configurations. These guides may be constructed of low-friction materials to prevent carton damage while ensuring proper orientation throughout the transfer process. The guide adjustment mechanisms may be designed for tool-less operation, facilitating rapid changeover between different package formats.

For transportation between facilities, the carton transfer conveyor 132 may be designed with a locking mechanism that may secure the conveyor in a fixed position within the second container 110. This mechanism may include pins or clamps that may engage with mounting points on the container floor or walls. The locking system may be designed to prevent movement during transit while allowing for quick release when transitioning to the operational configuration.

The carton transfer conveyor 132 may include sensing systems to monitor package flow and detect potential issues. These sensors may include photoelectric eyes or proximity sensors that may detect package presence and spacing. The sensing system may be integrated with the control architecture to provide real-time feedback on conveyor operation and may trigger alerts if abnormal conditions are detected.

The carton transfer conveyor 132 may be designed with consideration for cleaning and sanitization requirements. The belt surface may be easily accessible for cleaning, and the frame may be designed without horizontal surfaces or crevices that could collect debris. Drainage features may be incorporated to prevent liquid accumulation during cleaning procedures.

For enhanced functionality, the carton transfer conveyor 132 may include accumulation capabilities that may allow packages to queue temporarily if downstream equipment experiences a momentary stoppage. This accumulation feature may help maintain continuous operation of upstream equipment during minor disruptions. The accumulation system may include pressure-sensitive controls that may prevent excessive back pressure on packages during accumulation periods.

The carton transfer conveyor 132 may be equipped with emergency stop capabilities that may be integrated with the overall safety system of the containerization line. Emergency stop buttons may be positioned at strategic locations along the conveyor length, allowing operators to quickly halt operation if safety concerns arise. The emergency stop system may include redundant circuits to ensure reliable operation.

The carton transfer conveyor 132 may be mounted on a stable base with leveling capabilities to ensure proper operation regardless of slight variations in container positioning or ground surface. The leveling system may include adjustable feet or other mechanisms that may be fine-tuned during setup to ensure optimal conveyor performance.

The carton transfer conveyor 132 may incorporate modular design principles that may allow for reconfiguration based on specific operational requirements. Extension sections may be added or removed to adjust conveyor length, and curve sections may be incorporated to optimize space utilization within the second container 110. This modularity may enhance the versatility of the containerization line across different deployment scenarios.

For enhanced product tracking, the carton transfer conveyor 132 may include scanning stations that may verify package codes or labels as they move through the system. These scanning stations may utilize barcode readers, RFID sensors, or vision systems depending on the tracking requirements. The scanning data may be integrated with the production facility's inventory management system for seamless tracking throughout the distribution chain.

For packages requiring specific orientation for subsequent processing, the carton transfer conveyor 132 may include alignment mechanisms that may rotate or position packages as needed. These mechanisms may utilize pneumatic actuators or servo motors to provide precise control over package positioning. The alignment system may be programmable to accommodate different package types and downstream equipment requirements.

### H. A Pallet Lift

As shown in FIG. 1, the platform 100 may include a pallet lift 134. As shown in FIG. 1, the pallet lift 134 is preferably disposed in the second container 110, though other arrangements may be possible. In particular, the pallet lift is preferably disposed at the first end 112 of the second container 110, located at or near the cargo dock. In this way, the filled and packaged cans or bottles may be deposited on pallets at the cargo dock of the production facility.

The pallet lift 134 may be designed to efficiently stack and prepare filled, packaged containers for transportation and distribution. The pallet lift 134 may be positioned within the second container 110 near the first end 112, allowing for convenient transfer of palletized products to the production facility's cargo dock. The pallet lift 134 may be mounted on a movable platform that may allow for repositioning between transportation and operational configurations without requiring removal from the container.

The pallet lift 134 may help facilitate palletization of the packaged bottles or cans. The pallet lift 134 may receive and retain or store the filled and packaged bottles or cans. The bottles or cans may be placed on the pallet lift 134 from the bottling or canning line by a worker (e.g., a human or robotic worker). In some embodiments, the pallet lift 134 may rotate about a central axis and/or move up and/or down to allow for easier loading of the bottles and/or cans on the pallet. The pallet lift 134 may optionally include a stretch wrapper to stabilize and retain the packaged bottles or cans.

In the operational configuration, the pallet lift 134 may be positioned to optimize workflow from the carton transfer conveyor 132 through the palletization process. The height of the pallet lift 134 may be adjustable to ensure proper alignment with adjacent equipment and to accommodate different pallet configurations. This adjustment may be accomplished through mechanical or hydraulic systems that may be operated without requiring extensive disassembly.

The pallet lift 134 may incorporate a hydraulic lifting mechanism capable of raising loaded pallets to various heights for efficient stacking. This lifting mechanism may utilize heavy-duty hydraulic cylinders or electric actuators designed to handle the substantial weight of fully loaded pallets. The lift mechanism may include safety features such as overload protection and emergency lowering capabilities to prevent accidents during operation.

For pallet loading, the pallet lift 134 may include a receiving platform that may accept packaged containers from the carton transfer conveyor 132. This platform may incorporate roller or belt sections that may facilitate smooth transfer of packages onto the pallet. Guide rails or alignment features may be included to ensure proper positioning of packages during the palletization process.

The pallet lift 134 may optionally include a rotational capability that may allow the pallet to rotate about a vertical axis during loading. This rotational feature may provide operators with access to all sides of the pallet without requiring repositioning of the pallet or operator movement around the pallet. The rotation mechanism may include a bearing assembly mounted beneath the pallet platform and may be powered by an electric motor with variable speed control.

For enhanced stability of palletized products, the pallet lift 134 may incorporate a stretch wrapping mechanism. This mechanism may apply stretch film around the stacked packages, securing them to the pallet for safe transportation and storage. The stretch wrapper may include a film carriage that may move vertically along a mast while the pallet rotates, ensuring complete coverage of the pallet load. The tension of the stretch film may be adjustable to accommodate different package types and weights.

In some embodiments, a roof of a container (e.g., the second container 110) in which the pallet lift 134 is disposed may be modified by raising the roof at least in the vicinity of the pallet lift to facilitate palletization.

For transportation between facilities, the pallet lift 134 may be secured in a configuration that may optimize weight distribution within the second container 110. Locking mechanisms may prevent movement of the lift platform, rotational components, and stretch wrapper during transit, protecting both the pallet lift 134 and surrounding equipment from damage. These locks may be designed for quick release when transitioning to the operational configuration.

The pallet lift 134 may include a control system that may allow operators to select from predetermined stacking patterns based on package size, shape, and pallet dimensions. These patterns may be optimized for stability, space utilization, and compatibility with standard shipping requirements. The control interface may be integrated with the overall containerization line control system for coordinated operation.

The pallet lift 134 may incorporate safety features such as presence-sensing devices that may detect operator proximity and automatically stop movement if an operator enters a designated safety zone. Emergency stop buttons may be positioned at strategic locations around the pallet lift 134 for immediate shutdown if needed. Light curtains or other safety barriers may prevent access to hazardous areas during operation.

For operation in limited height environments, the pallet lift 134 may be designed with a low-profile configuration when in the lowered position. In some embodiments, the roof of the second container 110 may include a raised section or pop-out extension specifically in the area above the pallet lift 134 to provide additional vertical clearance for pallet stacking operations.

The pallet lift 134 may include load cells or other weight measurement devices that may monitor the weight of palletized products. This information may be used for inventory management, shipping documentation, and verification of proper loading. The weight measurement system may be calibrated to provide accurate readings regardless of pallet position on the lift platform.

For enhanced product tracking, the pallet lift 134 may incorporate a labeling system that may apply pallet identification labels to completed pallets. These labels may include product information, lot numbers, date codes, and other traceability data. The labeling system may be integrated with the production facility's inventory management system for seamless tracking throughout the distribution chain.

For operation with a wide range of products and packaging formats, the pallet lift 134 may include adjustable guide systems and format parts that may be quickly reconfigured for different package dimensions. These adjustments may be designed for tool-less operation, minimizing changeover time between different product runs. Digital position indicators may provide visual feedback to operators during format changes, ensuring proper setup.

The pallet lift 134 may be mounted on heavy-duty casters or rails that may allow for movement between the transportation configuration and the operative configuration. These movement mechanisms may include locking features to secure the pallet lift 134 in position during operation. The movement system may be designed to allow repositioning without requiring specialized equipment or excessive force.

For enhanced operator ergonomics, the pallet lift 134 may include height-adjustable control panels and interface devices that may be positioned for comfortable use by operators of various heights. The controls may be designed with intuitive layouts and clear labeling to minimize training requirements and reduce the potential for operational errors.

### I. A Carbonation System

In some embodiments, the platform 100 may optionally include a carbonation system 136. The carbonation system 136 may be used to carbonate the fluid prior to filling the bottles or cans.

The carbonation system 136 may be designed to efficiently introduce carbon dioxide into beverages prior to filling, providing consistent carbonation levels without requiring extended residence time in bright tanks. The carbonation system 136 may be positioned within the first container 102, typically between the chiller 127 and the filling system 126, ensuring that the fluid may be properly carbonated at the optimal temperature before entering the filling process. The carbonation system 136 may be mounted on a movable platform that may allow for repositioning between transportation and operational configurations without requiring removal from the container.

In the operational configuration, the carbonation system 136 may be positioned to optimize workflow from the chiller 127 to the filling system 126. The height of the carbonation system 136 may be adjustable to ensure proper alignment with adjacent equipment and to accommodate different fluid transfer requirements. This adjustment may be accomplished through mechanical or hydraulic systems that may be operated without requiring extensive disassembly.

The carbonation system 136 may utilize a carbonation stone or sintered metal diffuser that may introduce carbon dioxide gas into the chilled fluid. The diffuser may be constructed of food-grade stainless steel or ceramic material with microscopic pores that may create fine bubbles for efficient gas dissolution. The pore size may be selected to optimize carbonation efficiency while minimizing foaming or excessive turbulence in the fluid stream.

In embodiments, the carbonation system may carbonate the fluid substantially on-demand, without the need for the fluid to spend an extended time in a bright tank or other vessel for carbonating. The fluid may be cooled (e.g., by a chiller) to a near-freezing temperature (e.g., about 35° F. or cooler) before entering the carbonation system 136.

For control of carbonation levels, the carbonation system 136 may incorporate a pressure regulation system that may maintain consistent carbon dioxide pressure during the carbonation process. This regulation system may include pressure transducers, regulators, and control valves that may work in concert to maintain target pressure regardless of fluctuations in the carbon dioxide supply. The pressure settings may be adjustable to accommodate different beverage types and desired carbonation levels.

The carbonation system 136 may include temperature monitoring capabilities that may verify that the fluid remains at or near the optimal temperature for carbonation throughout the process. Temperature sensors may be positioned at strategic locations within the system to provide real-time feedback. If temperature variations are detected, the system may automatically adjust carbonation parameters or alert operators to potential issues.

For transportation between facilities, the carbonation system 136 may be secured in a configuration that may optimize weight distribution within the first container 102. Locking mechanisms may prevent movement during transit, protecting both the carbonation system 136 and surrounding equipment from damage. These locks may be designed for quick release when transitioning to the operational configuration.

The carbonation system 136 may incorporate in-line carbonation measurement devices that may verify carbonation levels before the fluid enters the filling system 126. These measurement devices may utilize technologies such as pressure-temperature equilibrium testing or vibration frequency analysis to determine dissolved carbon dioxide content. The measurement data may be used for real-time adjustments to carbonation parameters and may be recorded for quality assurance purposes.

Control systems for the carbonation system 136 may allow for adjustment of carbonation pressure, flow rate, and residence time. These parameters may be modified based on beverage type, temperature, and desired carbonation level. The control interface may be integrated with the overall containerization line control system for coordinated operation.

The carbonation system 136 may include a clean-in-place (CIP) system that may facilitate thorough cleaning and sanitization of product contact surfaces between production runs. The CIP system may include spray balls, circulation pumps, and chemical dosing equipment that may deliver cleaning and sanitizing solutions to all internal surfaces. The system may be programmed to execute predetermined cleaning cycles with appropriate temperature, chemical concentration, and duration parameters.

For enhanced product quality, the carbonation system 136 may include dissolved oxygen monitoring capabilities that may help prevent excessive oxygen pickup during the carbonation process. This monitoring may be particularly valuable for oxygen-sensitive products such as beer. The system may automatically adjust carbonation parameters to minimize oxygen introduction based on real-time measurements.

For operation with a wide range of products, the carbonation system 136 may include product changeover features that may minimize cross-contamination between different production runs. These features may include dedicated product pathways or easily removable product contact parts that may be exchanged between runs. The system may also include automated product changeover sequences that may guide operators through the necessary steps for switching between different products.

For enhanced safety, the carbonation system 136 may incorporate pressure relief valves and rupture discs that may prevent over-pressurization in the event of control system failure or blockage. Carbon dioxide sensors may be positioned near the carbonation system 136 to detect potential gas leaks. The safety systems may be integrated with the overall containerization line safety architecture, including emergency shutdown capabilities.

The carbonation system 136 may include a carbon dioxide recovery system that may capture and reuse gas that would otherwise be vented during the carbonation process. This recovery system may include collection chambers, filters, and compression equipment that may prepare recovered gas for reintroduction into the carbonation process. The recovery system may significantly reduce carbon dioxide consumption during operation, particularly during startup and shutdown phases.

The carbonation system 136 may be mounted on heavy-duty casters or rails that may allow for movement between the transportation configuration and the operative configuration. These movement mechanisms may include locking features to secure the carbonation system 136 in position during operation. The movement system may be designed to allow repositioning without requiring specialized equipment or excessive force.

For enhanced process control, the carbonation system 136 may include flow rate monitoring and control capabilities that may ensure consistent residence time within the carbonation chamber. This flow control may be accomplished through variable speed pumps or flow control valves that may adjust based on real-time measurements. The flow control system may be integrated with the carbonation pressure controls to maintain consistent carbonation levels regardless of throughput variations.

### J. A Drainage Capture System

In some embodiments, the platform 100 may optionally include a drainage capture system 138. The drainage capture system 138 may be used to capture any fluid (e.g., water, the produced fluid, etc.) prior overflow or runoff from the filling process.

The drainage capture may include one or more drainage grates dispose in the floor of one or more (e.g., each) container. For example, drainage grates may be placed proximate to the filling station 126, the rinser 122, and/or any other locations where fluid is likely to escape containment. The drainage grates may be connected to a collection tank that receives and retains the drainage or runoff from operation of the filling line. In this way, the system may be operable within contaminating the outside environment, even where there is no access to a sewer system. The drainage capture system 138 may be designed to efficiently collect, contain, and manage liquid waste generated during the containerization process. The drainage capture system 138 may be integrated throughout the mobile fluid containerization line to help facilitate proper handling of rinse water, product spillage, cleaning solutions, and/or the like. This system may be particularly valuable when operating in locations without direct access to municipal sewer systems or when environmental regulations require controlled disposal of liquid waste.

The drainage capture system 138 may include a network of drainage grates strategically positioned in the floor of one or more containers at locations where fluid spillage may be anticipated. As non-limiting examples, these drainage grates may be installed proximate to the filling station 126, the rinser 122, and/or other areas where fluids may be handled or where cleaning operations may occur. The grates may be designed with appropriate slot sizes to prevent debris from entering the drainage system while allowing efficient liquid flow.

Beneath the drainage grates, the system may incorporate sloped channels that may direct liquid toward collection points. These channels may be constructed of corrosion-resistant materials suitable for food and beverage environments. The slope of these channels may be engineered to ensure proper flow without creating areas where liquid could pool or stagnate. The channels may include smooth transitions and rounded corners to facilitate complete drainage and thorough cleaning.

The drainage capture system 138 may include one or more collection tanks positioned within or beneath the containers to receive and temporarily store liquid waste. These tanks may be constructed of food-grade materials with smooth interior surfaces to prevent bacterial growth and facilitate cleaning. The tanks may be sized based on anticipated liquid waste volume during typical production runs, with sufficient capacity to accommodate cleaning operations between runs.

For monitoring purposes, the drainage capture system 138 may incorporate level sensors within the collection tanks that may alert operators when tanks approach capacity. These sensors may be integrated with the overall monitoring system 144 to provide real-time status information and may trigger automatic alerts when intervention is required. The monitoring capabilities may include overflow prevention features that may halt liquid-generating processes if tank levels become critical.

The drainage capture system 138 may include pumping mechanisms that may transfer collected liquid from the tanks to appropriate disposal points. These pumps may be self-priming and may be capable of handling liquids with suspended solids that might be present in the waste stream. The pumping system may include filtration components to remove larger particulates before discharge, protecting downstream systems and facilitating compliance with disposal regulations.

For transportation between facilities, the drainage capture system 138 may be designed with secure tank closures and anti-splash features that may prevent liquid movement or spillage during transit. Tanks may be equipped with isolation valves that may be closed during transportation to prevent liquid migration through the drainage network. These transportation safeguards may be integrated with the system's transition between operational and transportation configurations.

The drainage capture system 138 may incorporate clean-in-place (CIP) capabilities that may allow for thorough sanitization of the drainage channels, tanks, and associated components. The CIP system may include spray nozzles positioned to provide complete coverage of internal surfaces. Cleaning solution may be circulated through the system to remove residues and sanitize surfaces between production runs.

For enhanced environmental compliance, the drainage capture system 138 may include sampling ports that may allow for testing of liquid waste before disposal. These sampling points may be positioned to provide representative samples of the collected liquid. The system may also include documentation features that may record volumes, disposal methods, and test results for regulatory reporting purposes.

The drainage capture system 138 may be designed with consideration for different types of liquid waste that may be generated during various production scenarios. Separate collection pathways may be provided for product spillage versus cleaning chemicals when required by disposal regulations. The system may include neutralization capabilities for pH adjustment of cleaning solutions before disposal when necessary.

For operation in environmentally sensitive areas, the drainage capture system 138 may include advanced treatment options such as filtration, separation, and/or biological treatment components that may process liquid waste to meet stringent discharge requirements. These treatment capabilities may be modular and may be deployed based on specific operational needs and local regulations.

The drainage capture system 138 may be equipped with quick-connect fittings for external discharge connections, facilitating rapid setup and teardown when deploying or relocating the containerization line. These connections may include backflow prevention devices to protect the drainage system from external contamination. The connection points may be standardized to accommodate various disposal options, including direct sewer connections, holding tanks, or treatment systems.

The drainage capture system 138 may include odor control features such as sealed connections, vapor traps, and ventilation systems that may prevent unpleasant odors from affecting the working environment. These features may be particularly important when collected liquid may remain in the system for extended periods before disposal.

K. A Monitoring system

In some embodiments, the platform 100 may optionally include a monitoring system 140. The monitoring system 140 may be used to monitor conditions within the containers during operation of the bottling line.

The monitoring system 140 may include one or more sensor for monitoring conditions within at least one (e.g., each) container during operation of the platform 100. As non-limiting examples, the one or more sensors may include a temperature sensor, a humidity sensor, an air quality sensor, a vibration sensor, a sound sensor and/or any other sensor useful in capturing data related to the conditions of the operating environment surrounding the platform 100. In embodiment, the monitoring system 140 may be used to verify the operating conditions for compliance with one or more requirements for working conditions (e.g., as may be specified by OSHA and/or other governmental or non-governmental agencies) and/or one or more food safety requirements (e.g., as may be specified by the FDA, USDA, and/or other governmental or non-governmental agencies). The monitoring system 140 may be designed to comprehensively track and record environmental conditions, equipment performance, and/or operational parameters throughout the mobile fluid containerization process. This system may utilize a network of sensors strategically positioned throughout the containers to provide real-time data collection and analysis. The monitoring system 140 may be integrated with the overall control architecture of the containerization line, allowing for automated responses to detected conditions that fall outside acceptable parameters.

For environmental monitoring, the system may incorporate temperature sensors positioned at locations throughout both containers. These sensors may measure ambient temperatures within different zones of the containerization line, with particular attention to the clean room 124 and areas containing temperature-sensitive equipment. The temperature monitoring capabilities may help ensure that proper environmental conditions are maintained for both product quality and equipment performance. Temperature data may be logged at regular intervals for quality assurance documentation and regulatory compliance purposes.

Humidity sensors may be included in the monitoring system 140 to track relative humidity levels throughout the containerization environment. These sensors may be particularly important in the clean room 124, where excessive humidity could potentially promote microbial growth or affect product integrity. The humidity monitoring system may trigger alerts if levels exceed predetermined thresholds, allowing operators to take corrective action before product quality could be compromised.

Air quality monitoring may be another function of the monitoring system 140. Particulate sensors may measure airborne contaminants within the clean room 124, verifying the effectiveness of the filtration systems and positive pressure maintenance. These sensors may detect particles of various sizes, with particular focus on those most relevant to beverage production sanitation requirements. Additional air quality parameters such as volatile organic compounds or specific gases may also be monitored depending on the specific production requirements.

The monitoring system 140 may include pressure differential sensors that may verify the maintenance of positive pressure within the clean room 124 relative to surrounding areas. These sensors may continuously measure the pressure gradient across clean room boundaries, ensuring that airflow remains directed outward to prevent contaminant ingress. Pressure monitoring may be particularly valuable during door openings or other events that could potentially compromise the controlled environment.

For equipment performance monitoring, the system may incorporate vibration sensors attached to mechanical components throughout the containerization line. These sensors may detect changes in vibration patterns that could indicate developing mechanical issues before they result in equipment failure. The vibration monitoring capabilities may be particularly valuable for rotating equipment such as pumps, motors, and conveyor systems, potentially reducing unplanned downtime through predictive maintenance.

Sound level monitoring may be included to comply with occupational safety standards, and/or to detect unusual acoustic signatures that may indicate equipment problems. Sound sensors may be positioned in operator work areas and near major equipment components. The sound monitoring system may provide real-time readings and/or time-weighted averages for regulatory compliance documentation.

The monitoring system 140 may include flow meters and pressure transducers throughout fluid handling systems to verify proper operation of filling, rinsing, and cleaning processes. These sensors may track fluid consumption rates, pressures, and/or temperatures at various points in the system, helping to ensure consistent performance and potentially identifying issues such as blockages, leaks, or pump problems before they affect product quality.

For production monitoring, the system may incorporate counters and/or vision systems that may track container throughput at various points in the containerization line. These monitoring capabilities may provide real-time or near real-time production statistics and may help identify bottlenecks or efficiency issues within the process. Production data may be logged and analyzed to identify opportunities for process optimization or to document production volumes for inventory management purposes.

The monitoring system 140 may include power monitoring capabilities that may track electrical consumption throughout the containerization line. This monitoring may help identify equipment that may be operating outside normal parameters or may be consuming excessive power. When operating with the optional generator 142, the power monitoring system may track fuel levels, generator output, and load distribution to ensure reliable operation throughout the production run.

Data collection from sensors may be centralized in a main control system that may provide local and/or remote monitoring capabilities. This control system may include industrial-grade computing hardware housed in environmentally protected enclosures within the containers. The computing system may run specialized software for data acquisition, analysis, and storage, with user interfaces accessible through displays at strategic locations throughout the containerization line.

The monitoring system 140 may incorporate alert capabilities that may notify operators of conditions requiring attention. These alerts may be categorized by severity, with critical issues triggering immediate notifications through visual indicators, audible alarms, and potentially text messages or emails to designated personnel. Less urgent alerts may be logged for later attention during routine maintenance periods. The alert thresholds may be configurable based on specific product requirements and operational parameters.

For enhanced accessibility, the monitoring system 140 may include remote access capabilities that may allow authorized personnel to view system status and historical data from outside the containerization line. This remote access may be secured through encryption and authentication protocols to prevent unauthorized access. The remote capabilities may be particularly valuable for technical support, allowing experts to assist with troubleshooting without requiring on-site presence.

The monitoring system 140 may include data logging and reporting functions that may automatically generate documentation for quality assurance and regulatory compliance purposes. These reports may include environmental conditions, production statistics, cleaning verification, and equipment performance metrics. The reporting system may be configurable to meet the specific documentation requirements of different regulatory frameworks or customer specifications.

The monitoring system 140 may incorporate predictive analytics capabilities that may identify trends in operational data that could indicate developing issues before they reach alert thresholds. These analytics may examine patterns across multiple parameters to detect subtle changes that might not be apparent when examining individual metrics. The predictive capabilities may help transition from reactive to proactive maintenance approaches, potentially reducing downtime and extending equipment life.

Integration with the production facility's existing systems may be facilitated through standard communication protocols and data exchange formats. This integration may allow for seamless information flow between the mobile containerization line and the production facility's inventory management, quality control, and production scheduling systems. The integration capabilities may be configurable to accommodate various facility systems without requiring extensive customization.

### Additional Optional Features

The portable filling line may be implemented in various alternative embodiments to accommodate different production requirements, container types, and operational environments. These alternative embodiments may incorporate different configurations, additional features, or specialized components to enhance functionality across diverse applications.

In some embodiments, an additional set of modules or components for further facilitating operation of the platform 100.

For example, some embodiments may optionally include one or more custom containers and/or trailers provided for storage of pallets of empty cans or bottles for introduction into the filling line at the depalletize 120, pallets of filled and sealed cans or bottles from the pallet lift 134, packaging (e.g., a carton, box, plastic wrap, can carrier, and/or the like) for the filled and sealed cans or bottles, and/or any other supplies for use in operation of the platform 100.

As another example, some embodiments may optionally include one or more custom containers and/or trailers provided for mobile water processing to produce potable water through filtration, UV sterilization and/or ozone disinfection. The one or more custom containers or trailers may include compressor and generator components to provide electrical supply to the water processing equipment, the first container 102, the second container 110, and/or the fixed location (e.g., the production facility) in the event that electricity is needed or desired.

Untreated water may enter a treatment trailer through a sanitary fitting, such as a tri-clamp fitting, from a water source on location. As an example, the water source may be for canned/bottled drinking water production and/or for direct use. Various properties of the untreated water (e.g., turbidity, pH level, etc.) may be measured prior to treatment. The properties may be communicated to a computing device on the treatment trailer. The untreated water may flow through a filtration system, which may include one or more of a backwash filter, a carbon filter, a microfilter, and/or an ultraviolet disinfection system. Sensors on the system may measure various properties (e.g., turbidity, pH level, etc.) of the filtered water.

The filtered water may flow through an ozone disinfection system. In the ozone disinfection system, the filtered water may reach a disinfection level of 0.2 ppm ozone. This residual level of ozone may be monitored and/or logged for (among other reasons) compliance and quality assurance purposes. The disinfected and filtered water may leave the treatment trailer through a sanitary fitting, such as a tri-clamp fitting, and may be transferred to the first container 102, the second container 110, and/or other locations at the production facility.

The treatment trailer may include all necessary equipment components for operation, including components for electricity and/or compressed air generation and/or storage. Partitions (e.g., walls) may be provided to separate the water treatment equipment from the electrical and air supply equipment, to mitigate any health and safety risks. In some embodiments, the treatment trailer may include air quality monitoring equipment, decibel monitoring equipment, air conditioning, emergency ventilation, personal protective equipment (PPE), and/or tools required for fire suppression and/or electrical maintenance.

The processing environment within the treatment trailer may meet requirements of a public water system, as stipulated by the FDA and/or EPA. For example, the requirements may include use of stainless steel components, washable surfaces, and sufficient drainage in various portions of the treatment trailer.

In one alternative embodiment, the portable filling line may be configured specifically for high-speed can filling operations. This embodiment may utilize a multi-head rotary filler capable of processing up to 250 cans per minute, substantially exceeding the standard 80-100 container rate of the base configuration. The high-speed embodiment may incorporate additional accumulation conveyors between processing stations to maintain continuous operation despite brief interruptions at individual stations. This configuration may be particularly valuable for larger production runs where maximizing throughput may be a priority.

A low-volume premium packaging embodiment may alternatively be configured for specialty products requiring more delicate handling or complex packaging. This configuration may operate at slower speeds, perhaps 30-50 containers per minute, but may incorporate more sophisticated filling technology such as nitrogen dosing, specialized cap application systems for cork or unique closure types, or advanced label application equipment. The premium packaging embodiment may include enhanced vision systems for quality verification throughout the process, ensuring that high-value products meet exacting presentation standards.

For operations in remote locations or regions with unreliable infrastructure, an enhanced self-sufficiency embodiment may be implemented. This configuration may expand upon the optional generator and water processing capabilities, potentially including larger fuel storage capacity, solar panels for supplementary power generation, and advanced water treatment systems capable of processing water from virtually any source. The enhanced self-sufficiency embodiment may include expanded storage areas for consumables and spare parts, allowing for extended operation without external supply chains.

In regions with extreme climate conditions, a climate-adapted embodiment may incorporate enhanced environmental control systems. For cold environments, this may include additional insulation, heating systems for critical components, and anti-freeze protection for fluid pathways. For hot environments, expanded cooling capacity, heat-resistant components, and enhanced ventilation may be provided. The climate-adapted embodiment may include specialized seals and materials selected for performance across wider temperature ranges than standard configurations.

A pharmaceutical-grade embodiment may be configured for products requiring higher levels of sanitation or regulatory compliance. This configuration may incorporate enhanced clean room features such as HEPA filtration with higher efficiency ratings, additional air locks between zones, and continuous particle monitoring. Surface materials throughout the system may be selected for compatibility with more aggressive sanitizing agents, and the documentation systems may be expanded to meet pharmaceutical validation requirements. This embodiment may be particularly suitable for functional beverages with health claims or products marketed for sensitive populations.

In some applications, a modular expansion embodiment may allow for scaling the system based on production requirements. This configuration may include standardized interface points between processing stations, allowing for additional modules to be inserted into the processing line as needed. For example, a basic system may be expanded with additional filling heads, secondary packaging options, or specialized inspection stations without requiring replacement of the entire system. The modular expansion embodiment may provide a growth path for producers whose volume requirements may increase over time.

For beverage producers requiring multiple product streams, a multi-product embodiment may incorporate parallel processing capabilities within the portable system. This configuration may include separate filling systems for different product types, with appropriate clean-in-place (CIP) systems to prevent cross-contamination. The control systems may be expanded to manage multiple product flows simultaneously or in sequence, potentially allowing for continuous operation during product changeovers. This embodiment may be particularly valuable for producers with diverse product portfolios who may benefit from filling different products during a single deployment.

A cold-chain compliance embodiment may be specifically designed for temperature-sensitive products requiring continuous refrigeration. This configuration may incorporate enhanced insulation throughout the containers, refrigeration systems with redundant backup capabilities, and continuous temperature monitoring with automated alerting for any excursions outside specified ranges. The filling system may be designed to maintain product temperature throughout the containerization process, potentially including chilled conveyors and handling systems. This embodiment may be particularly suitable for dairy-based beverages, cold brew coffee, or other products where temperature control may be critical for quality and safety.

For producers requiring enhanced quality verification, an inspection-intensive embodiment may incorporate additional sensing and monitoring capabilities throughout the containerization process. This configuration may include vision systems for container inspection before filling, fill-level verification after filling, closure inspection after sealing, and label verification after application. Additional sensors may monitor parameters such as dissolved oxygen levels, headspace gas composition, or seal integrity. The inspection-intensive embodiment may be particularly valuable for premium products where quality consistency may be a critical competitive factor.

A rapid deployment embodiment may be designed for situations requiring exceptionally quick setup and teardown cycles. This configuration may include simplified utility connections, pre-configured equipment settings for common products, and streamlined transition mechanisms between transportation and operational configurations. The control systems may include automated startup and shutdown sequences that may minimize the technical expertise required for system commissioning. This embodiment may be particularly valuable for event-based production scenarios or emergency response situations where containerization capabilities may need to be established quickly.

For producers working with highly sensitive products, an aseptic filling embodiment may incorporate features to maintain sterile conditions throughout the filling process. This configuration may include expanded clean room capabilities with multiple pressure zones, sterilization systems for containers before filling, and filling equipment designed to prevent any environmental exposure during the filling process. The aseptic filling embodiment may include expanded monitoring systems specifically tracking sterilization parameters and environmental conditions critical for maintaining aseptic status. This configuration may be particularly suitable for preservative-free beverages or products with extended shelf life requirements.

A remote monitoring embodiment may expand upon the standard monitoring capabilities to provide comprehensive remote access and control capabilities. This configuration may include additional sensors throughout the system, enhanced data processing capabilities, and secure communication systems allowing for real-time monitoring and control from distant locations. The remote monitoring embodiment may include predictive maintenance features that may identify potential issues before they impact production, allowing for proactive intervention. This configuration may be particularly valuable for operations in remote locations or for producers utilizing centralized technical support teams.

For operations requiring enhanced worker safety in challenging environments, a safety-optimized embodiment may incorporate additional protective features throughout the system. This configuration may include expanded guarding around moving components, enhanced emergency stop systems with faster response times, and additional sensors monitoring operator proximity to hazardous areas. Operational controls may be positioned to minimize ergonomic strain, and access platforms may include additional fall protection features. The safety-optimized embodiment may include expanded monitoring specifically tracking safety-related parameters and automatically documenting compliance with applicable safety standards.

A specialized closure embodiment may be designed for products requiring unique sealing methods beyond standard caps or can ends. This configuration may include equipment for applying cork closures, crown caps, twist-off caps, child-resistant closures, or tamper-evident seals. The closure systems may be designed for rapid changeover between different closure types, potentially allowing for mixed closure formats within a single production run. This embodiment may be particularly valuable for producers using distinctive closure systems as part of their brand identity or for products requiring specialized closure formats for functional reasons.

A data-intensive embodiment may expand upon the standard monitoring capabilities to provide comprehensive data collection and analysis throughout the containerization process. This configuration may include additional sensors measuring a wider range of parameters, expanded data storage capabilities, and advanced analytics systems that may identify patterns or correlations not immediately apparent in raw data. The data-intensive embodiment may include integration capabilities with enterprise resource planning (ERP) or manufacturing execution systems (MES), allowing for seamless data flow between the containerization line and broader business systems. This configuration may be particularly valuable for producers seeking to implement data-driven continuous improvement programs or those requiring detailed documentation for regulatory compliance.

For producers requiring enhanced flexibility in package formats, a multi-pack embodiment may incorporate equipment for creating various retail-ready configurations. This configuration may include systems for creating four-packs, six-packs, variety packs, or other groupings beyond standard cases. The multi-pack equipment may include specialized carriers, shrink-wrapping capabilities, or handle application systems appropriate for different retail presentations. This embodiment may be particularly valuable for producers seeking to offer multiple package formats to different retail channels without requiring separate production runs.

For operations requiring enhanced protection against environmental contamination, a controlled atmosphere embodiment may incorporate features to maintain specific gas compositions within critical areas of the containerization process. This configuration may include expanded capabilities for introducing nitrogen or other inert gases to displace oxygen, specialized sealing systems to maintain gas composition within enclosed areas, and continuous monitoring of atmospheric conditions throughout the process. The controlled atmosphere embodiment may be particularly suitable for oxygen-sensitive products such as certain wines, beers, or functional beverages containing ingredients susceptible to oxidation.

For producers requiring enhanced flexibility in product formulation, an in-line blending embodiment may incorporate capabilities for creating finished products from component ingredients within the containerization process. This configuration may include precision dosing systems for various ingredients, mixing equipment to ensure homogeneity, and expanded quality verification to confirm proper formulation before filling. The in-line blending embodiment may be particularly valuable for producers offering products with variable formulations or those seeking to minimize finished goods inventory by creating products on-demand.

For operations in highly regulated environments, a compliance-optimized embodiment may incorporate enhanced documentation and verification systems throughout the containerization process. This configuration may include expanded data collection capabilities specifically focused on regulatory requirements, automated compliance checking against predefined parameters, and comprehensive record-keeping systems designed to streamline regulatory inspections or audits. The compliance-optimized embodiment may be particularly valuable for producers operating in highly regulated categories or regions with stringent documentation requirements.

A specialized product recovery embodiment may be designed to minimize product loss during startup, shutdown, or changeover operations. This configuration may include expanded drainage systems with product separation capabilities, automated purge sequences that may minimize product waste during line priming, and sophisticated control systems that may optimize timing of various operations to reduce product loss. The product recovery systems may be particularly valuable for producers working with high-value products where waste represents significant cost or those with sustainability commitments related to minimizing product disposal.

For producers requiring enhanced flexibility in production data management, an integrated MES (Manufacturing Execution System) embodiment may incorporate comprehensive production tracking and management capabilities throughout the containerization process. This configuration may include expanded data collection from all processing stations, real-time performance monitoring with automated alerting for deviations from targets, and comprehensive reporting capabilities for various operational metrics. The MES integration may provide seamless data flow between the containerization line and broader business systems. This embodiment may be particularly valuable for producers implementing data-driven management approaches or those requiring detailed production documentation for regulatory or quality assurance purposes.

A specialized quality assurance embodiment may incorporate enhanced sampling and testing capabilities throughout the containerization process. This configuration may include automated sampling systems at critical control points, on-site laboratory capabilities for performing detailed product analyses, and comprehensive documentation systems for tracking quality parameters throughout production runs. The quality assurance enhancements may be particularly valuable for producers operating in highly regulated categories or those where consistent product quality provides significant competitive advantage.

A specialized inventory management embodiment may incorporate enhanced tracking capabilities for consumables and components throughout the containerization process. This configuration may include automated monitoring of critical supplies such as caps, labels, or cleaning chemicals, predictive algorithms for anticipating replenishment needs, and potentially automated ordering capabilities integrated with supplier systems. The inventory management enhancements may be particularly valuable for operations in remote locations where supply chain reliability may be challenging or those seeking to minimize working capital tied up in excess inventory.

For operations requiring enhanced protection against external contamination, a positive pressure embodiment may expand beyond the standard clean room to create controlled environments throughout the containerization process. This configuration may include enhanced air handling systems capable of maintaining positive pressure in multiple zones, airlock entries between areas of different classification, and continuous monitoring of pressure differentials throughout the system. The positive pressure enhancements may be particularly valuable for producers of aseptic products or those operating in environments with high levels of airborne contaminants.

A specialized compliance documentation embodiment may incorporate enhanced record-keeping capabilities specifically designed to streamline regulatory inspections or audits. This configuration may include automated generation of compliance reports, secure storage of critical production parameters, and potentially direct reporting interfaces with regulatory systems. The compliance documentation enhancements may be particularly valuable for producers operating in highly regulated categories or those distributing to markets with stringent documentation requirements.

### III. Platform Operation

Embodiments of the present disclosure provide a platform operative by a set of methods. The following depicts an example of at least one method of a plurality of methods that may be performed by at least one of the aforementioned modules. Various hardware components may be used at the various stages of operations disclosed with reference to each module.

For example, although methods may be described as being performed by a single device, it should be understood that, in some embodiments, different operations may be performed by different elements in operative communication.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones described below. Moreover, various stages may be added or removed from the without altering or departing from the fundamental scope of the depicted methods and systems disclosed herein.

### A. Master Method

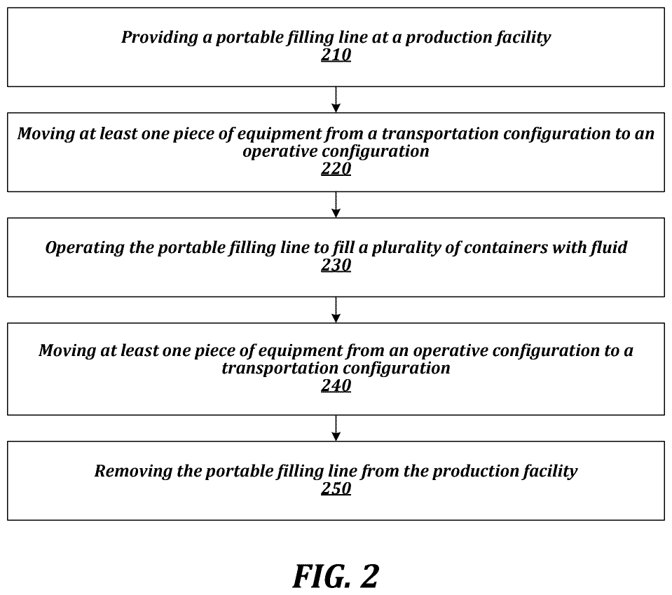

Consistent with embodiments of the present disclosure, a method may be performed by at least one of the aforementioned modules. The method may be embodied as, for example, but not limited to, computer instructions, which, when executed, perform the method. FIG. 2 is a flow chart setting forth the general stages involved in a method 200 consistent with an embodiment of the disclosure for providing the fluid containerizing platform 100.

Method 200 may begin at stage 210 where a portable filling line comprised of filling equipment disposed within a plurality of containers may be provided at or relocated to a production facility site. In some embodiments, the production facility site may be a site where one or more fluids (e.g., beverages) are produced for human and/or animal consumption. In some embodiments, the production facility site may be a facility that includes a water supply.

This initial stage may involve transporting the portable filling line to the location where fluid containerization may be performed. The portable filling line may be transported using commercial trucking services, with the containers secured to flatbed trailers or chassis designed for container transport. Upon arrival at the production facility site, the containers may be positioned adjacent to cargo docks to facilitate access for loading empty containers and unloading filled products.

In some embodiments, this stage may include site preparation activities to ensure proper positioning of the containers. The ground surface may need to be level and capable of supporting the weight of the fully equipped containers. Temporary ramps or platforms may be installed if the cargo dock height does not match the container door height. Utility connections may be established during this stage, including water supply lines, electrical connections if shore power will be utilized, and/or drainage connections if available. In embodiments utilizing the optional generator 142, fuel supplies may be verified and replenished as needed before beginning operations.

The containers may be positioned with their access doors aligned with the cargo docks to facilitate efficient workflow. The first container 102 may be positioned with its first end 104 at a first cargo dock, while the second container 110 may be positioned with its first end 112 at a second cargo dock, preferably adjacent to the first cargo dock. This arrangement may allow empty containers to enter the system at one cargo dock and filled, packaged products to exit at the adjacent cargo dock, creating a linear workflow through the containerization process.

Method 200 may proceed to stage 220, where one or more pieces of equipment from a transportation configuration to an operative configuration without removing the equipment from the plurality of containers. For example, stage 220 may include moving at least one piece of equipment within at least one of the containers. The one or more pieces of equipment may be mounted on rails, wheels, casters, or other devices to assist in movement of the equipment. Moving the equipment may allow for the equipment to be in a location and/or orientation that allows for efficient and safe operation of the mobile canning line. In embodiments, movement of the equipment is accomplished without unloading any equipment from the containers.

During transportation, certain equipment components may be secured in positions that optimize weight distribution and minimize the risk of damage. These components may need to be repositioned for efficient operation once the containers are in place at the production facility.

For example, the filling system 126 may be mounted on heavy-duty casters that allow it to be moved from a transportation position near the center of the first container 102 to an operational position that optimizes workflow from the rinser 122. This movement may be accomplished by releasing locking mechanisms that secure the filling system during transport, then carefully rolling the equipment to its operational position. Once properly positioned, the locking mechanisms may be reengaged to prevent movement during operation.

Similarly, the depalletizer 120 may be configured with a rotational platform that may be locked in a fixed position during transport. During setup, this platform may be unlocked to allow rotation, providing operators with access to all sides of palletized containers without requiring repositioning of the pallet. The depalletizer 120 may also include a lift mechanism that may be secured in a lowered position during transport and raised to an operational height during setup.

In the second container 110, the cartoner 130 may be repositioned from its transportation configuration to an operative configuration that creates an efficient workflow from the transfer conveyor 128. The pallet lift 134 may be moved from a secured transport position to an operational position that facilitates easy loading and unloading at the cargo dock.

The transfer conveyor 128 connecting the two containers may also be moved to an operational position during this stage. During transport, the conveyor may be stored in a folded or compressed configuration within one of the containers. During setup, the conveyor may be extended and secured between the containers, creating a continuous path for containers to move from the filling system 126 to the cartoner 130. Alignment between the apertures in each container may be verified, and seals around these apertures may be checked to maintain environmental separation between the clean room 124 and the external environment.

For equipment with height adjustability, such as the filling system 126 or cartoner 130, this stage may include adjusting the equipment to the appropriate height for the specific containers being processed. Guide rails and container handling components may be adjusted to accommodate the particular container dimensions. These adjustments may be performed using manual controls or through the central control system, depending on the specific equipment configuration.

In embodiments including the optional carbonation system 136, this stage may include connecting product lines from the production facility to the carbonation system and verifying proper operation of pressure control systems. The chiller 127 may be powered on during this stage to begin cooling to the appropriate temperature for the specific product being containerized.

The clean room 124 environment may be established during this stage by activating air handling systems that create positive pressure within the designated area. HEPA filtration systems may be verified to ensure proper operation before product contact occurs. In embodiments with the optional monitoring system 144, sensors may be calibrated and baseline readings may be established for temperature, humidity, particulate levels, and other relevant parameters.

Throughout this configuration process, equipment may remain within the containers, with all movement occurring internally. This approach may eliminate the need for external lifting equipment or extensive setup procedures, significantly reducing the time required to transition from arrival to operational readiness. The configuration process may be designed to be completed by a small team of operators, typically in a matter of hours rather than days.

Method 200 may proceed to stage 230, where the equipment is operated to fill a plurality of bottles and/or cans at the production facility site. In embodiments, the equipment is operated within the containers. In some embodiments, the containers may include at least a first container and a second container connected by a conveyor. A first container may be disposed at a first cargo dock and a second container may be disposed at a second cargo dock. The filling equipment may be disposed such that, in operation, empty cans are provided at the first cargo dock, the cans proceed through the filling equipment, and filled and packaged cans are provided from the filling line at the second cargo dock.

This operational stage represents the core functionality of the portable filling line, where empty containers enter the system, are processed through various stages, and emerge as filled, sealed, and packaged products ready for distribution.

The operational sequence may begin with the introduction of empty containers to the depalletizer 120. Pallets of empty containers may be delivered to the first cargo dock and positioned on the depalletizer platform. As layers of containers are removed from the pallet, they may be placed on a conveyor that transports them to the rinser 122. The depalletizer 120 may raise the pallet incrementally as each layer is depleted, maintaining an ergonomic working height for operators.

At the rinser 122, containers may be inverted and subjected to high-pressure sprays of filtered water, sanitizing solution, or ionized air. This process may remove any dust, debris, or contaminants that may have accumulated during container manufacturing or transportation. After rinsing, containers may be re-inverted to their upright position and conveyed into the clean room 124 environment.

Within the clean room 124, containers may proceed to the filling system 126. For carbonated beverages, the fluid may first pass through the optional carbonation system 136, where carbon dioxide may be introduced under pressure to achieve the desired carbonation level. The fluid may be chilled by the chiller 127 to the optimal temperature for filling, typically around 35° F. for carbonated beverages. This chilling may enhance carbonation retention and may reduce foaming during the filling process.

The filling system may incorporate nitrogen dosing capabilities for still beverages, providing enhanced product quality and shelf stability. Nitrogen dosing may be particularly valuable for still beverages where oxygen displacement may be desired without introducing carbonation. The nitrogen dosing system may be positioned within the filling system 126 or as a separate module integrated into the product flow path before filling.

For still beverage applications, the nitrogen dosing system may utilize food-grade nitrogen gas introduced through a specialized diffuser designed to create micro-bubbles for efficient dissolution. The diffuser may be constructed of sintered stainless steel or ceramic material with precisely sized pores that may optimize nitrogen introduction while minimizing turbulence in the fluid stream. The pore size and distribution may be selected based on fluid viscosity and desired nitrogen concentration.

The nitrogen dosing system may include precision pressure regulation components that may maintain consistent nitrogen pressure during the dosing process. This regulation system may incorporate pressure transducers, regulators, and control valves that may work in concert to maintain target pressure regardless of fluctuations in the nitrogen supply. The pressure settings may be adjustable to accommodate different beverage types and desired nitrogen levels.

Temperature monitoring capabilities may be incorporated into the nitrogen dosing system to verify that the fluid remains at an appropriate temperature for nitrogen dissolution throughout the process. Temperature sensors may be positioned at strategic locations to provide real-time feedback. If temperature variations are detected, the system may automatically adjust dosing parameters or alert operators to potential issues.

The nitrogen dosing system may include in-line measurement devices that may verify dissolved nitrogen levels before the fluid enters the filling heads. These measurement devices may utilize technologies such as membrane-based sensors or optical detection methods to determine dissolved gas content. The measurement data may be used for real-time adjustments to dosing parameters and may be recorded for quality assurance purposes.

At the filling system 126, containers may be filled with precise volumes of fluid. For cans, this may be followed by lid application and seaming operations that hermetically seal the container. For bottles, caps, corks, or other closure types may be applied and secured. The filling system 126 may operate at rates of approximately 80-100 containers per minute, though this rate may vary based on container type, product characteristics, and specific equipment configuration.

Filled and sealed containers may exit the clean room 124 and proceed to the transfer conveyor 128, which may transport them from the first container 102 to the second container 110. Upon entering the second container 110, containers may proceed to the cartoner 130, where they may be grouped and packaged into appropriate secondary packaging formats such as cartons, trays, or multi-pack configurations.

Packaged products may then move via the carton transfer conveyor 132 to the pallet lift 134, where they may be stacked onto pallets in predetermined patterns for efficient storage and transportation. The pallet lift 134 may include stretch wrapping capabilities to secure the stacked products to the pallet. Completed pallets may be removed from the second cargo dock for storage or immediate distribution.

Throughout this operational stage, the optional monitoring system 144 may continuously track environmental conditions, equipment performance, and product parameters. This monitoring may help ensure consistent product quality and may provide early warning of potential issues before they impact production. The system may automatically adjust operating parameters based on monitoring data or may alert operators when manual intervention may be required.

In embodiments utilizing the optional generator 142, power supply may be continuously monitored to ensure stable operation throughout the production run. The drainage capture system 138 may collect and manage liquid waste from the rinsing and filling processes, preventing contamination of the production facility floor and facilitating proper disposal.

The operational stage may continue until the scheduled production run has been completed or until available product from the production facility has been containerized. During operation, the portable filling line may function as a self-contained production facility, requiring minimal interaction with the broader production facility infrastructure beyond the supply of product for containerization.

Method 200 may proceed to stage 240, where one or more pieces of equipment from an operative configuration to a transportation configuration, without removing the equipment from the plurality of containers. For example, stage 240 may include moving at least one piece of equipment within at least one of the containers. As discussed above with respect to stage 220, the one or more pieces of equipment may be mounted on rails, wheels, casters, or other devices to assist in movement of the equipment. Moving the equipment may allow for the equipment to be in a location and/or orientation that allows for efficient and safe transportation of the mobile canning line within the containers. In embodiments, movement of the equipment is accomplished without unloading any equipment from the containers.

Equipment that was repositioned during setup in stage 220 may be returned to its transportation configuration. The filling system 126 may be moved from its operational position to a transport position that optimizes weight distribution within the first container 102. Locking mechanisms may be engaged to secure the equipment during transit, preventing movement that could cause damage or affect balance.

The depalletizer 120 may be secured in its transportation configuration, with rotation and lift mechanisms locked in their most stable positions. The pallet lift 134 in the second container 110 may be lowered and secured for transport. The cartoner 130 may be repositioned to its transportation configuration and locked in place.

The transfer conveyor 128 connecting the containers may be disconnected and returned to its storage configuration within one of the containers. Apertures between the containers may be sealed to prevent environmental ingress during transportation. All access doors and panels may be secured to prevent movement during transit.

In embodiments with the optional carbonation system 136, product lines may be purged and disconnected from the production facility supply. The chiller 127 may be drained if necessary to prevent damage from freezing during cold weather transportation. The drainage capture system 138 may be emptied according to appropriate disposal protocols, and tanks may be secured for transport.

The clean room 124 environmental systems may be deactivated in a controlled sequence to prevent contamination of product contact surfaces. In embodiments with the optional monitoring system 144, data from the production run may be backed up and secured for future reference or quality assurance purposes.

Throughout this reconfiguration process, all equipment may remain within the containers, with no components requiring removal or external storage. This approach may significantly reduce teardown time compared to traditional mobile containerization operations that require equipment to be unloaded and reloaded for each deployment.

Method 200 may proceed to stage 250, where the portable filling line is moved or relocated away from the production facility site. The relocation may be accomplished by, for example, hauling or towing containers via a truck, train, or other motorized vehicle.

Once all equipment has been secured in its transportation configuration, the containers may be prepared for transport to their next destination. This preparation may include disconnecting any remaining utility connections, removing temporary ramps or platforms, and performing final inspections to ensure all components are properly secured.

The containers may be loaded onto appropriate transportation vehicles such as flatbed trucks or chassis designed for container transport. Securing mechanisms may be engaged to prevent movement during transit. In embodiments utilizing the optional generator 142 or other fuel-powered systems, fuel supplies may be verified to meet transportation safety requirements.

Transportation documentation may be prepared, including weight certificates, content manifests, and any special handling instructions. If the portable filling line will be crossing international borders, appropriate customs documentation may be prepared to facilitate smooth passage.

The relocation process may be coordinated with the next scheduled deployment location to ensure proper timing and site preparedness. This coordination may include confirming dock availability, utility requirements, and product readiness at the next location. By efficiently managing the relocation process, downtime between production runs may be minimized, enhancing the overall utilization of the portable filling line.

For extended transit periods or during periods of non-use, additional preservation measures may be implemented. These may include climate control within the containers to prevent temperature extremes that could damage sensitive equipment, security measures to prevent unauthorized access, and periodic maintenance checks to ensure all systems remain in proper working condition.

Upon arrival at the next deployment location, the method may return to stage 210, beginning the cycle again with positioning and setup at the new production facility site. This cyclical operation may allow the portable filling line to serve multiple production facilities with professional-grade containerization capabilities without requiring any facility to invest in permanent equipment or dedicate valuable space to containerization operations.

In some embodiments, the portable filling line may include additional optional features that may enhance functionality across different operational scenarios. For example, the optional water processing capabilities may allow the system to operate in locations with limited water infrastructure by processing available water to the standards required for beverage production. This capability may be particularly valuable in remote locations or regions with unreliable municipal water supplies.

The optional carbonation system 136 may provide on-demand carbonation capabilities, eliminating the need for production facilities to maintain carbonation equipment or bright tanks for product holding. This system may be particularly valuable for smaller producers who may not have the space or resources for dedicated carbonation infrastructure.

For operation in areas with limited or unreliable electrical infrastructure, the optional generator 142 may provide complete power independence. This capability may expand the potential deployment locations for the portable filling line to include remote areas, developing regions, or facilities with limited electrical capacity.

The monitoring system 144 may provide comprehensive data collection throughout the containerization process, helping to ensure consistent product quality and regulatory compliance. This data may be particularly valuable for producers operating in highly regulated categories or those seeking to maintain precise quality standards across multiple production runs.

In each application of method 200, the portable filling line may provide a complete containerization solution that may be temporarily deployed without requiring permanent installation or significant facility modifications. This approach may allow production facilities to access professional-grade containerization capabilities on an as-needed basis, potentially reducing capital investment requirements and maximizing facility space utilization for core production activities.

The following is claimed:

1. A method for mobile fluid containerization, comprising:
providing a mobile containerization line at a production facility, the mobile containerization line comprising one or more shipping containers housing fluid containerization equipment;
transitioning at least a portion of the fluid containerization equipment from a transportation configuration to an operative configuration without removing the equipment from the one or more shipping containers;
establishing a clean room environment within at least one of the one or more shipping containers by creating positive air pressure with filtered air surrounding a portion of the containerization equipment;
cooling a fluid product using a chiller system housed within the one or more shipping containers;
filling a plurality of containers with the cooled fluid product using filling equipment disposed within the one or more shipping containers;
transitioning the fluid containerization equipment from the operative configuration back to the transportation configuration; and
relocating the mobile containerization line from the production facility.

2. The method of claim 1, further comprising:
connecting multiple shipping containers with at least one transfer conveyor to create a continuous containerization line.

3. The method of claim 1, wherein establishing the clean room environment comprises:
filtering ambient air through a filtration system;
pressurizing an enclosed area surrounding the filling equipment; and
maintaining positive air pressure within the enclosed area during the filling operation.

4. The method of claim 1, further comprising:
operating the mobile containerization line using a self-contained power generation system housed within one of the one or more shipping containers.

5. The method of claim 1, further comprising:
monitoring environmental conditions within the shipping containers during the filling operation using a monitoring system.

6. The method of claim 1, further comprising:
capturing drainage from the containerization process using a drainage capture system integrated within the one or more shipping containers.

7. The method of claim 1, further comprising:
carbonating the fluid product prior to filling the containers using a carbonation system housed within one of the shipping containers.

8. A mobile fluid containerization system, comprising:
a first shipping container housing depalletizing equipment and fluid filling equipment;
a second shipping container housing cartoning equipment and palletizing equipment;
a transfer conveyor connecting the first shipping container to the second shipping container;
a clean room enclosure surrounding at least a portion of the fluid filling equipment, the clean room enclosure maintaining positive air pressure with filtered air;
a chiller system disposed within one of the shipping containers and configured to cool fluid prior to filling;
a power generation system configured to provide electrical power to the containerization system independent of external power sources; and
wherein at least a portion of the equipment in the first shipping container or the second shipping container is movable between a transportation configuration and an operative configuration without being removed from the shipping containers.

9. The mobile fluid containerization system of claim 8, wherein the first shipping container comprises:
a depalletizer configured to receive and store pallets of empty containers;
a rinser configured to clean the empty containers using filtered water or sanitizer; and
a filling system configured to fill the cleaned containers with cooled fluid and seal the containers.

10. The mobile fluid containerization system of claim 8, wherein the second shipping container comprises:
a cartoner configured to place filled containers into carriers;
a carton transfer conveyor configured to move packaged containers; and
a pallet lift configured to facilitate palletization of the packaged containers.

11. The mobile fluid containerization system of claim 8, further comprising:
a monitoring system configured to monitor environmental conditions within the shipping containers during operation;
a drainage capture system configured to collect fluid overflow or runoff from the containerization process; and
a compressor configured to provide pressurized air to one or more components of the containerization system.

12. The mobile fluid containerization system of claim 8, wherein the clean room enclosure complies with FDA regulations for food and beverage handling.

13. The mobile fluid containerization system of claim 8, further comprising:
a carbonation system configured to carbonate fluid prior to filling the containers; and
wherein the chiller system is configured to cool the fluid to a near-freezing temperature before the fluid enters the carbonation system.

14. The mobile fluid containerization system of claim 8, wherein the containerization system is configured to produce filled containers at a rate of approximately 80-100 containers per minute.

15. A method for operating a mobile fluid containerization line, comprising:
relocating a portable filling line to a production facility site, the portable filling line comprising filling equipment disposed within a plurality of shipping containers;
arranging the plurality of shipping containers at the production facility site such that a first shipping container is positioned at a first cargo dock and a second shipping container is positioned at a second cargo dock;
reconfiguring equipment within at least one of the shipping containers from a transportation configuration to an operative configuration without removing the equipment from the at least one shipping container;
receiving empty containers at a first end of the first shipping container;
rinsing the empty containers using a rinser disposed within the first shipping container;
filling the rinsed containers with fluid using a filling system disposed within the first shipping container;
transferring the filled containers from the first shipping container to the second shipping container via a transfer conveyor;
packaging the filled containers using equipment disposed within the second shipping container; and
outputting packaged filled containers at a first end of the second shipping container.

16. The method of claim 15, wherein reconfiguring equipment comprises:
moving at least one piece of equipment along rails, wheels, or casters within at least one of the shipping containers from a position optimized for weight distribution during transportation to a position optimized for operational efficiency.

17. The method of claim 15, further comprising:
maintaining a clean room environment surrounding at least the filling system by:
filtering air entering the clean room environment;
maintaining positive air pressure within the clean room environment relative to surrounding areas; and
controlling temperature within the clean room environment.

18. The method of claim 15, further comprising:
receiving a pallet of empty containers at a depalletizer disposed within the first shipping container;
rotating or vertically adjusting the depalletizer to facilitate removal of empty containers from the pallet; and
placing the empty containers onto a conveyor system for transport to the rinser.

19. The method of claim 15, further comprising:
chilling the fluid to a near-freezing temperature using a chiller disposed within one of the shipping containers prior to filling the containers;
capturing drainage from the containerization process using drainage grates disposed in a floor of at least one of the shipping containers; and
providing electrical power to the filling equipment using a generator disposed within one of the shipping containers.

20. The method of claim 15, wherein packaging the filled containers comprises:
placing the filled containers into carriers using a cartoner disposed within the second shipping container;
conveying the carriers containing filled containers to a pallet lift disposed within the second shipping container; and
palletizing the carriers containing filled containers using the pallet lift.
